(19) United States
(12) Patent Application Publication
(10) Pub. No.: US 2016/0260119 A1
(43) Pub. Date: Sep. 8, 2016

(54) SYSTEM AND METHOD OF DETERMINING CONNECTION ROUTE OF TERMINAL REQUESTING CONNECTION

(71) Applicant: NAVER CORPORATION, Seongnam-si (KR)

(72) Inventors: Dong Ki Kim, Seongnam-si (KR); Hyeon Sik Moon, Seongnam-si (KR); Eun Mi Kim, Seongnam-si (KR); Hyeon Su Jeong, Seongnam-si (KR)

(21) Appl. No.: 15/061,501

(22) Filed: Mar. 4, 2016

(30) Foreign Application Priority Data
Mar. 5, 2015 (KR) 10-2015-0031120

(51) Int. Cl. G06Q 30/02; H04M 3/22

(52) U.S. Cl. CPC G06Q 30/0231; H04M 3/2281

(57) ABSTRACT

A system and a method of determining the connection route between two terminals includes a calling route information provider configured to compare first call information related to a first terminal according to a phone number link object selection signal on a web page displayed on the first terminal and second call information related to a call signal from a second terminal driven according to the phone number link object selection signal, and display some of the first call information on the second terminal according to a matching determination result of the phone number link object selection signal and the call signal; and a reward provider configured to compare state information of the first terminal and a reward providing condition received from the second terminal driven by the call signal to provide an accumulable reward to the first terminal satisfying the reward providing condition.

### CROSS-REFERENCE TO RELATED APPLICATION

This application claims the benefit of Korean Patent Application No. 10-2015-0031120, filed on Mar. 5, 2015, in the Korean Intellectual Property Office, the disclosure of which is incorporated herein in its entirety by reference.

### BACKGROUND

1. Field

One or more embodiments of the present invention relate to a system and a method of determining the connection route between two terminals, and providing a reward.

2. Description of the Related Art

Recently, the scale of the mobile communication market has rapidly grown, and mobile communication is now an essential element to modern people's lives. However, with such growth of the mobile communication market, there are adverse effect such as personal information leakage, and thus the number of spam calls has sharply increased. Specifically, unlike spam messages and spam emails, spam calls are more polluting as the spam calls require an immediate response from a user. In this regard, some mobile communication users do not answer any calls from callers who are not registered in their contact lists by using caller identification (ID) services. However, blocking all people other than those in the contact lists may have adverse effects, and even informative calls that are not promotional calls may also be blocked.

Meanwhile, as society becomes multifaceted and technologies are developed, a scope of selection for advertisers on advertising media is gradually increasing. For example, advertisements used to be offline advertisements, such as newspaper or television (TV) advertisements, but nowadays, the proportion of online advertisements is gradually increasing. Since effects of such online advertisements have huge differences based on their application fields, such as websites, search advertisements, cafes, blogs, and content advertisements, the advertisers need to carefully select advertising media. However, with respect to selecting an advertising medium, it is difficult for the advertisers to determine the efficiency of the advertising media since the advertisers do not know which advertisements the consumers have viewed.

Information disclosed in this Background section was already known to the inventors before achieving the inventive concept or is technical information acquired in the process of achieving the inventive concept. Therefore, it may contain information that does not form the prior art that is already known to the public in this country.

### SUMMARY

One or more embodiments include a system and a method of providing a reward, in which a callee is notified about a route through which a caller obtained a phone number of the callee.

One or more embodiments include a system and a method of providing a reward, in which information about advertising media viewed by the consumers that prompted them to call business operators, is provided to assist the business operators to select an advertising medium.

One or more embodiments include a system and a method of providing a reward, in which various messages related to a business of a business operator is transmitted to a consumer while the consumer and the business operator are talking over the telephone to provide smooth communication between the consumer and the business operator.

One or more embodiments include a system and a method of providing a reward, in which a call history is prepared while a consumer and a business operator are talking over the telephone or after the consumer and the business operator hang up and state information (a call, a reservation, a visit, and a payment) of the consumer is stored to efficiently manage the consumer.

One or more embodiments include a system and a method of providing, for business promotion, a reward, in which a business operator provides a certain reward to a consumer based on state information of the consumer.

One or more embodiments include a system and a method of providing a reward, in which a consumer who has accumulated rewards may use the rewards to receive various services.

Additional aspects will be set forth in part in the description which follows and, in part, will be apparent from the description, or may be learned by practice of the presented embodiments.

According to one or more embodiments, a system for providing a reward includes: a calling route information provider configured to compare first call information related to a first terminal according to a phone number link object selection signal on a web page displayed on the first terminal and second call information related to a call signal from a second terminal driven according to the phone number link object selection signal, and display some of the first call information on the second terminal according to a matching determination result of the phone number link object selection signal and the call signal; and a reward provider configured to compare state information of the first terminal and a reward providing condition received from the second terminal driven by the call signal to provide an accumulable reward to the first terminal satisfying the reward providing condition.

The system may further include a summary information generator configured to generate, upon receiving a selection signal from the second terminal, summary information by summing up a call history with respect to the first terminal.

The system may further include a transmitter configured to transmit information requested by the first terminal to the first terminal upon receiving a selection signal from the second terminal.

According to one or more embodiments, a method of providing a reward includes: comparing, by a calling route information provider, first call information related to a first terminal according to a phone number link object selection signal on a web page displayed on the first terminal and second call information related to a call signal from a second terminal driven according to the phone number link object selection signal, and displaying, by a calling route information provider, some of the first call information on the second terminal according to a matching determination result of the phone number link object selection signal and the call signal; and comparing, by a reward provider, state information of the first terminal and a reward providing condition received from the second terminal driven by the call signal to provide an accumulable reward to the first terminal satisfying the reward providing condition.

The method may further include generating, by a summary information generator, summary information by summing up a call history with respect to the first terminal upon receiving a selection signal from the second terminal.

The method may further include transmitting, by a transmitter, information requested by the first terminal to the first terminal upon receiving a selection signal from the second terminal.

According to one or more embodiments, a computer program is stored in a medium for executing the method by using a computer.

### BRIEF DESCRIPTION OF THE DRAWINGS

These and/or other aspects will become apparent and more readily appreciated from the following description of embodiments, taken in conjunction with the accompanying drawings in which:

FIG. 1 is a block diagram of a system for providing a reward, according to an embodiment;

FIG. 2 is a block diagram of a detailed structure of the calling route information provider of the system of FIG. 1;

FIG. 3 is a block diagram of a detailed structure of the reward provider of the system of FIG. 1;

FIG. 4 is a block diagram of a system for providing a reward, according to another embodiment;

FIG. 5 is a diagram for describing a relationship between a user terminal and the system of FIG. 1, according to an embodiment;

FIG. 6 is a diagram for describing a relationship between a user terminal and the system of FIG. 1, according to another embodiment;

FIG. 7 is a diagram for describing a relationship between a user terminal and the system of FIG. 1, according to another embodiment;

FIG. 8 is a diagram of a system for providing a reward, according to another embodiment;

FIGS. 9A-9D, 10A-10C, 11A-11F, 12A-12C, 13A-13E, 14A-14E, 15A-15B, 16A-16E, 17A-17B, 18A-18C and 19A-19B illustrate examples of information-related screens provided by a system for providing a reward, according to embodiments; and

FIG. 20 is a flowchart of a method of providing a reward, according to an embodiment.

### DETAILED DESCRIPTION

Advantages and features of one or more embodiments and methods of accomplishing the same may be understood more readily by reference to the following detailed description of the embodiments and the accompanying drawings. In this regard, the embodiments may have different forms and should not be construed as being limited to the descriptions set forth herein. Rather, these embodiments are provided so that this disclosure will be thorough and complete and will fully convey the concept of the embodiments to one of ordinary skill in the art, and the disclosure will only be defined by the appended claims. In the description of the embodiments, certain detailed explanations of related art are omitted when it is deemed that they may unnecessarily obscure the essence of the disclosure.

The terms used in the present specification are merely used to describe particular embodiments, and are not intended to limit the disclosure. An expression used in the singular encompasses the expression in the plural, unless it has a clearly different meaning in the context. In the present specification, it is to be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. While such terms as “first”, “second”, etc., may be used to describe various components, such components must not be limited to the above terms. The above terms are used only to distinguish one component from another.

As used herein, the term “and/or” includes any and all combinations of one or more of the associated listed items. Expressions such as “at least one of”, when preceding a list of elements, modify the entire list of elements and do not modify the individual elements of the list.

Herein, a “first user” may include a caller, a consumer, or a user, and a “first terminal” may include a device manipulated by the first user, for example, a mobile terminal, such as a laptop, a handheld device, a smart phone, or a tablet personal computer (PC), a general wired/wireless telephone, a desktop computer, or an arbitrary device using, or directly or indirectly connected to, one of the mobile terminal, the general wired/wireless telephone, and the smart phone. Herein, a “second user” may include an advertiser, a business owner, or a worker working in an advertising company or a company operated by an advertiser or a business owner, and moreover, may include an advertising company or a company itself. For example, the second user may include any company capable of providing a service to the first user, such as a specialized service company related to law, consulting, real estate, loan consulting, or an agent, a beauty service company related to a hair shop, a nail shop, plastic surgery, skin, or cosmetics, a transport service company related to a chauffeur service, a call-taxi, a dispatch rider service, a parcel service, or freight, an interior design and repair service company related to interior design, an on-site service, material sales, or a repair shop, a health and fitness service company related to a fitness center, various lessons related to exercises, or fitness products, a leisure and entertainment service company related to travel, leisure, a hobby, or accommodation, an education service company related to a private educational institute, private lessons, or an institution, or a high value service company related to a car, membership, or a luxury leisure product. Herein, a “second terminal” may include a device manipulated by the second user, for example, a mobile terminal, such as a laptop, a handheld device, a smart phone, or a tablet PC, a general wired/wireless telephone, a desktop computer, or an arbitrary device using, or directly or indirectly connected to, one of the mobile terminal, the general wired/wireless telephone, and the smart phone.

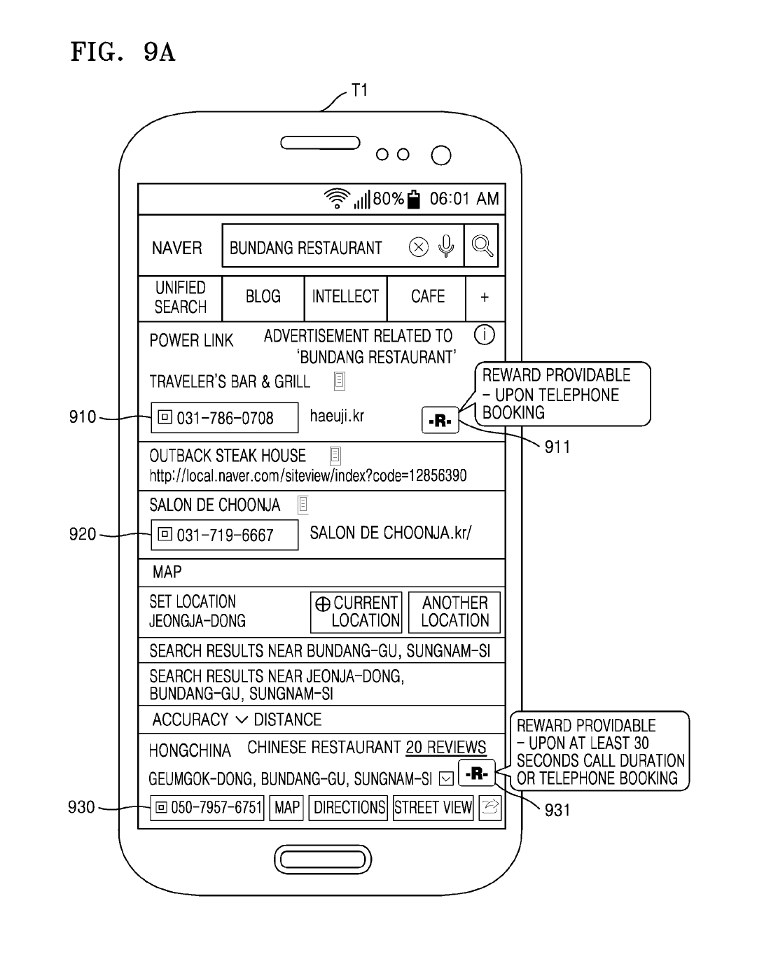

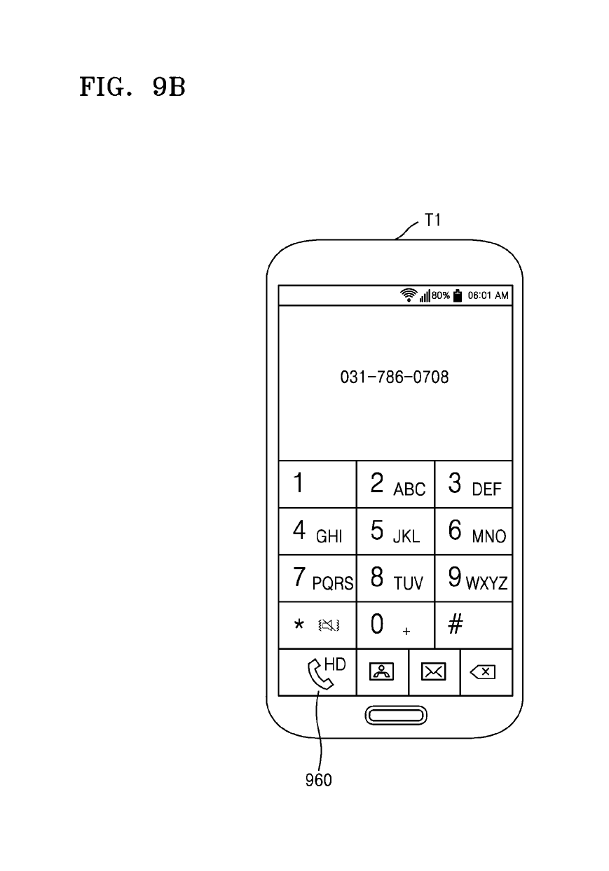

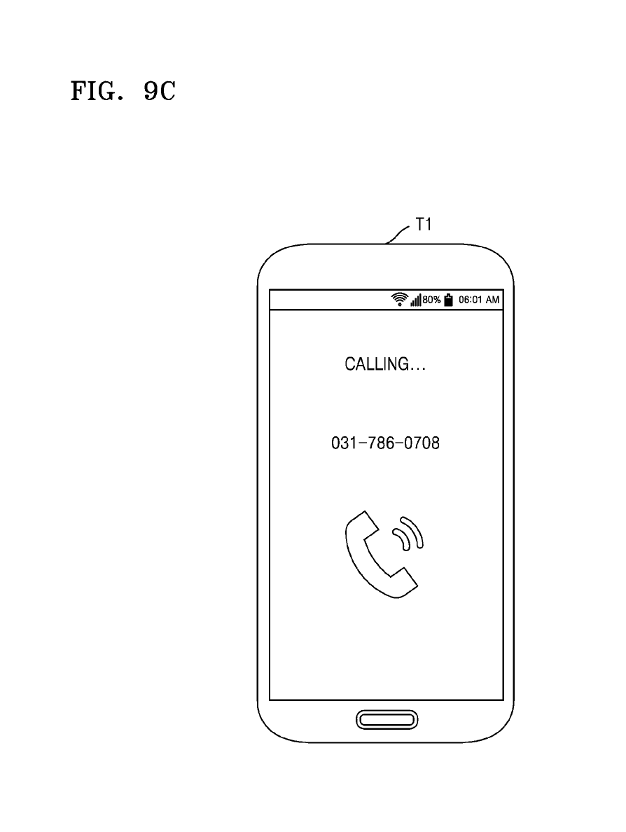

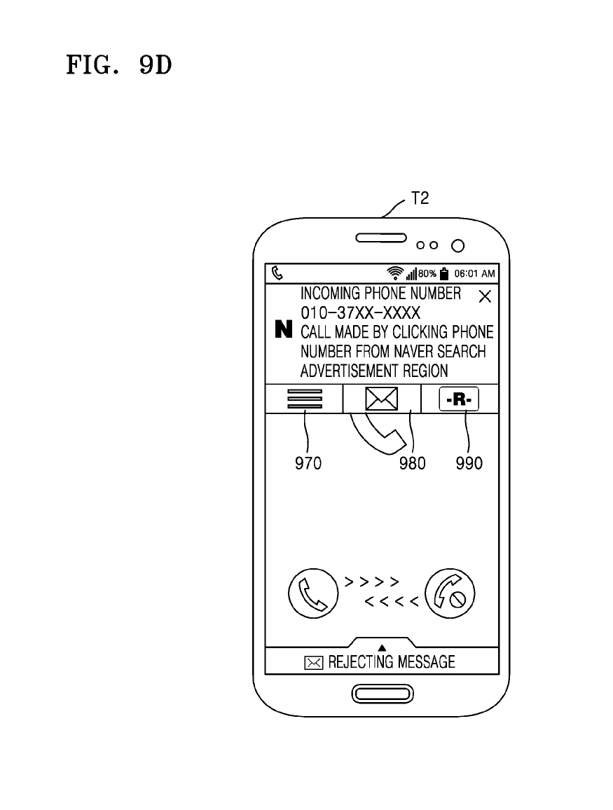

Herein, “calling route information (information of an outgoing call)” may include various types of information displayed on the second terminal and describing how the first user inputs a phone number of the second user to the first terminal. For example, when the first user tries to call the second user by selecting a phone number link object (refer to 910 of FIG. 9A) provided to the first user through a network, calling route information may be <call made by clicking phone number in search advertisement region>. Also, when the first user tries to call the second user by selecting the phone number link object (refer to 910 of FIG. 9A) provided to the first user through the network, the calling route information may include various types of information indicating how a phone number of the second user is input, such as information <input from network>, information <direct dial input> if the first user tries to call the second user by pressing a dial on the first terminal, or information <connection via QR code recognition> if the first user tries to call the second user by recognizing a quick response (QR) code by using the first terminal. Such calling route information may include some of call information of the first user or information processed according to the call information of the first user.

Herein, a “reward” may include a coupon, a gift card, accumulated money, mileage, a point, or a stamp provided by the second user to the first terminal of the first user according to an action of the first user with respect to the second terminal, the action satisfying a reward providing condition set by the second user. The first user may purchase a product on a web by using accumulated rewards, use a service provided by a third user associated with the second user, and moreover, change rewards into cash. Also, the second user may charge a reward to be provided to the first terminal by accessing a system for providing a reward.

One or more embodiments of the present invention will be described below in more detail with reference to the accompanying drawings. Those components that are the same or are in correspondence are rendered the same reference numeral regardless of the figure number, and redundant explanations are omitted.

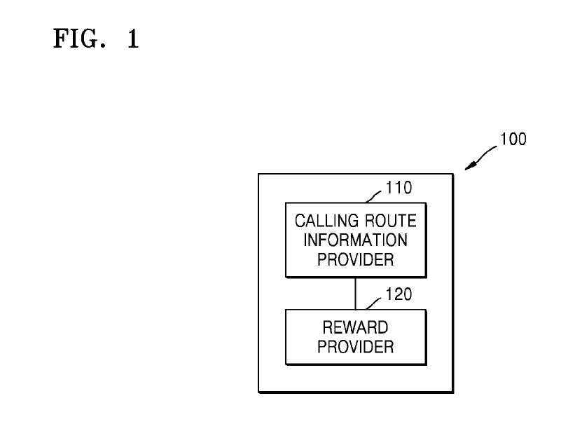

FIG. 1 is a block diagram of a system 100 for providing a reward, according to an embodiment. Referring to FIG. 1, the system 100 includes a calling route information provider 110 and a reward provider 120.

The calling route information provider 110 collects first call information of a first terminal according to selection on a phone number link object displayed on the first terminal through a user interface (UI) screen of a web page or an application through a network, and collects second call information related to a call signal from a second terminal driven according to a phone number link object selection signal of a first user. The calling route information provider 110 may compare at least some of the first call information and at least some of the second call information, and display some of the first call information on the second terminal based on the result of determining the relevance between the phone number link object selection signal and the call signal. Here, some of the first call information may be included in the calling route information described above.

In other words, the calling route information provider 110 provides to the second terminal the calling route information about how the first terminal obtained a phone number of a second user so as to provide meaningful information to both the first and second users. Accordingly, since the second user learns the calling route information together with a phone number (caller number) of the first user who called the second user on the second terminal, if the second user is an advertiser, the second user may determine a route by which a new customer is attracted, and if the first user is a general caller, the second user may determine whether a call made to the second terminal is a spam call or an informative call. Also, since the calling route information is displayed on the second terminal, the first user may increase a call connection probability even if the phone number of the first user is not stored in a contact list in the second terminal.

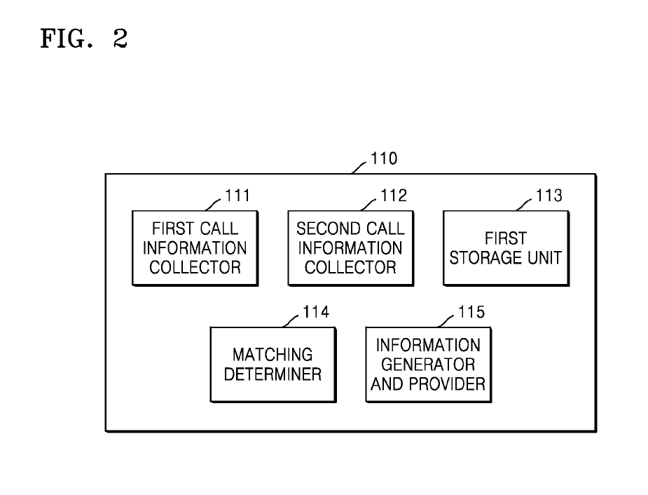

FIG. 2 is a block diagram of a detailed structure of the calling route information provider 110 of the system 100 of FIG. 1. Referring to FIG. 2, the calling route information provider 110 includes a first call information collector 111, a second call information collector 112, a first storage unit 113, a matching determiner 114, and an information generator and provider 115.

The first call information collector 111 collects the first call information as call information of the first terminal according to selection of a phone number link object provided to the first terminal through a network. Here, the first call information may include at least one of service details provided to the phone number link object, the time when the phone number link object is selected, a linked phone number linked to the phone number link object, a member who selected the phone number link object, a phone number of the first terminal, the time when the first terminal called the second terminal, a call duration between the first and second terminals, the time when a call between the first and second terminals is ended. The first call information may be stored in the first storage unit 113.

According to an embodiment, when the first user selects the phone number link object through a mobile website or a search window, the first call information collector 111 extracts information about which search keyword is used from an application or a search server. For example, when the first user makes a call by selecting a certain phone number link object in a search result window obtained by using <Bundang restaurant> as a search keyword from a certain web page on the first terminal, the first call information collector 111 may extract that <Bundang restaurant> is used as the search keyword. The first call information collector 111 may collect information about the search keyword that led to the phone number link object. The information about the search keyword may include information about which search keyword exposed the phone number of the second user. Thus, calls made to the second terminal may be distinguished according to search keywords.

The second call information collector 112 collects the second call information about a call signal from the second terminal. Here, the second call information may include at least one of the time of the call signal, the phone number of the second terminal, the phone number of the first terminal, a call duration between the first and second terminals, and the time when a call between the first and second terminals is ended. The second call information may be stored in the first storage unit 113.

The first storage unit 113 stores the first call information and the second call information. Also, the first storage unit 113 may store a source code. Here, the source code may include information that is matched and coded to each of general types of calling routes. For example, the source code may be <0001> when a calling route is <from a mobile website> or may be <0002> when a calling route is <from a contact list>, but the source code is not limited thereto and may vary. Also, the first storage unit 113 may store information about a clicked region, a clicked time, a clicked phone number, and a clicked keyword. Also, the first storage unit 113 may store information about the first user who joined the system 100 as a member, for example, information on a gender, an age, a residence, and an email address of the first user.

The matching determiner 114 matches the first call information collected by the first call information collector 111 and the second call information collected by the second call information collector 112 to track the first user. The matching determiner 114 may determine whether the first call information and the second call information match each other by comparing the time when the phone number link object is selected from a search screen displayed on the first terminal and the time when the call signal is received by the second terminal because there is generally only a small time difference between when the phone number link object is selected and when a call button is input. For example, the matching determiner 114 may determine that the first call information and the second call information match each other if the time difference is within several seconds. As such, the time difference for determining whether the first call information and the second call information match each other may be set by adjusting a variable of matching determining algorithm.

According to an embodiment, the matching determiner 114 determines whether the first call information and the second call information match each other by comparing the time when the first terminal called the second terminal according to the selection of the phone number link object, which is included in the first call information, and the time when the call signal is received, which is included in the second call information, by comparing a linked phone number included in the first call information and the phone number of the second terminal, which is included in the second call information, or by comparing a member who selected the phone number link object, which is included in the first call information, and the phone number of the first terminal, which is included in the second call information.

In detail, when the first user selects the phone number link object displayed on the first terminal, the linked phone number of the phone number link object is copied to a phone number input window of the first terminal, and when the first user presses a call button, the first call information is transmitted to the second terminal. The first call information may include at least one of a type of a service being used, a region clicked and selected by the first user, the time when the region is clicked and selected, the linked phone number, and the phone number of the first user. In addition, accuracy of matching may be increased by using various information collectable based on each of the phone numbers of the first and second terminals.

For example, the accuracy of matching may be increased by collecting not only the phone number of the first user who clicked the phone number link object from the first terminal, but also de-identification personal information collectable online, such as location information and a serial number of the first terminal, at the moment the phone number link object is clicked, when the call signal is received by the second terminal, determining a method of collecting location information based on a mobile carrier base station through the phone number of the first terminal and various types of information collectable online, and then comparing a similarity between information collected by the first and second terminals.

A type of service to which the current embodiment is applicable may include an application or a web for providing various search websites or other information, but the type of service is not limited thereto, and may include a web page of the second user having the phone number of the second terminal or of an entity related to the second user. In addition, the type of service may be an advertisement flyer including a QR code, and for example, when a call is made by scanning the advertisement flyer including the QR code, the type of service may include information about a location or an entity of distribution of the advertisement flyer. Information about a region clicked and selected by the first user by using the first terminal may include information about a search keyword, and the information about the search keyword may include information about which keyword search exposed the phone number of the second terminal.

When the matching determiner 114 determines that the first call information and the second call information match each other, the information generator and provider 115 generates and transmit information including some of the first call information or the calling route information processed based on the information including some of the first call information to the second terminal to be displayed. Information displayed on the second terminal may include at least one of service details provided to the phone number link object, a time when the phone number link object is selected, a linked phone number linked to the phone number link object, a member who selected the phone number link object, the phone number of the first terminal, and a search keyword that led to the phone number link object.

However, when the matching determiner 114 determines that the first call information and the second call information do not match each other, the information generator and provider 115 may only generate and transmit the phone number of the first terminal to the second terminal, and only the phone number of the first terminal may be displayed on the second terminal.

If the phone number of the first terminal is not collected by the first call information collector 111, for example, if the first terminal does not provide the phone number of the first terminal, and when the first user selects the phone number link object displayed on the search screen of the first terminal, the second terminal may detect that a call is received, and the matching determiner 114 may determine whether the first call information, from which the phone number of the first terminal is excluded, and the second information stored in the first storage unit 113 match each other.

Referring back to FIG. 1, the reward provider 120 may receive state information of the first terminal, which is received from the second terminal driven according to the call signal, after the phone number link object is selected from the first terminal, and compare the state information and a reward providing condition to provide an accumulable reward to the first terminal satisfying the reward providing condition.

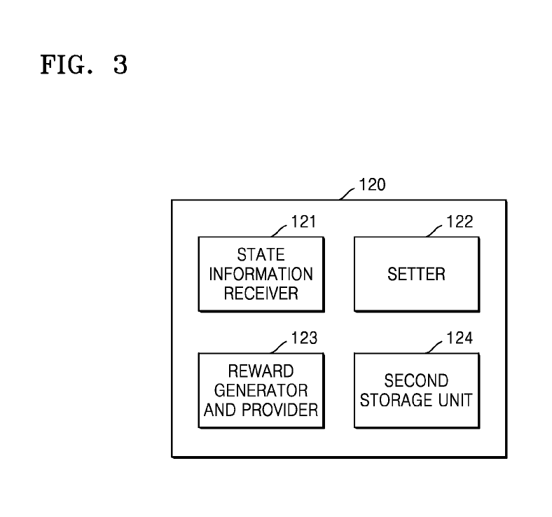

FIG. 3 is a block diagram of a detailed structure of the reward provider 120 of the system 100 of FIG. 1. Referring to FIG. 3, the reward provider 120 includes a state information receiver 121, a setter 122, a reward generator and provider 123, and a second storage unit 124.

The state information receiver 121 receives the state information of the first terminal, which is received from the second terminal driven according to the call signal, after the phone number link object is selected by the first terminal, and stores the state information of the first terminal in the second storage unit 124. Here, the state information of the first terminal may include first state information through fifth state information.

The first state information may include a state in which a bell rings while the call route information is displayed on the second terminal as the call signal is received by the second terminal according to selection of the phone number link object of the first terminal. Here, the first state information may be received from the second terminal according to an input of the second user.

The second state information may include a state in which the first and second users talk over the telephone as the second user presses a call button after the second terminal is rung. Here, the second state information may be subdivided according to a call duration between the first and second users. For example, the second state information may be subdivided into two first state information and two second state information according to a state in which a call duration is 10 seconds and a state in which a call duration is 60 seconds, respectively. Here, the second state information may be received from the second terminal according to an input of the second user during or after a telephone conversation between the first and second users.

The third state information may include a state in which the first user makes a reservation to visit the second user through the telephone conversation between the first and second users. Here, the third state information may be received from the second terminal according to an input of the second user during or after the telephone conversation between the first and second users.

The fourth state information may include a state in which the first user personally visits the second user, after making the reservation. Here, the fourth state information may be received from the second terminal according to an input of the second user after a personal visit of the first user to the second user is completed.

The fifth state information may include a state in which the first user makes a payment to the second user, after the first user visits the second user. Here, the fifth state information may be received from the second terminal according to an input of the second user after the payment is completed.

The setter 122 sets the reward providing condition to be provided to the first terminal, and stores the reward providing condition in the second storage unit 124. Here, the reward providing condition may include a reward providable according to the state information of the first terminal received from the second terminal, and different rewards may be provided based on the state information of the first terminal. Here, different rewards may mean that different amounts of rewards may be provided according to the state information of the first terminal, or different types of rewards may be provided according to the state information of the first terminal, such as points, gift cards, or mileage.

The setter 122 may set, as the reward providing condition, a condition in which a first reward is provided when the first state information is received from the second terminal, a condition in which a second reward is provided when the second state information is received from the second terminal, a condition in which a third reward is provided when the third state information is received from the second terminal, a condition in which a fourth reward is provided when the fourth state information is received from the second terminal, or a condition in which a fifth reward is provided when the fifth state information is received from the second terminal. Also, with respect to the condition in which the second reward is provided, different rewards may be provided according to a call duration. Also, a condition in which a bonus reward is provided when at least two pieces of the first through fifth state information are received from the second terminal may be set.

The reward generator and provider 123 compares the state information received by the state information receiver 121 and the reward providing condition set by the setter 122 to generate and provide a reward that is accumulable to the first terminal satisfying the reward providing condition.

The reward generator and provider 123 may compare the first state information received by the state information receiver 121 and the reward providing condition set by the setter 122, and when it is determined that a first reward providing condition is satisfied, generate and provide the first reward to the first terminal. The reward generator and provider 123 may compare the second state information received by the state information receiver 121 and the reward providing condition set by the setter 122, and when it is determined that a second reward providing condition is satisfied, generate and provide the second reward to the first terminal. The reward generator and provider 123 may compare the third state information received by the state information receiver 121 and the reward providing condition set by the setter 122, and when it is determined that a third reward providing condition is satisfied, generate and provide the third reward to the first terminal. The reward generator and provider 123 may compare the fourth state information received by the state information receiver 121 and the reward providing condition set by the setter 122, and when it is determined that a fourth reward providing condition is satisfied, generate and provide the fourth reward to the first terminal. The reward generator and provider 123 may compare the fifth state information received by the state information receiver 121 and the reward providing condition set by the setter 122, and when it is determined that a fifth reward providing condition is satisfied, generate and provide the fifth reward to the first terminal.

According to an embodiment, the reward generator and provider 123 may compare at least two pieces of the first through fifth state information received by the state information receiver 121 and the reward providing condition set by the setter 122, and when it is determined that at least two of the first through fifth reward providing conditions are satisfied, generate and provide at least two same rewards to the first terminal. Also, the reward generator and provider 123 may compare at least two pieces of the first through fifth state information received by the state information receiver 121 and the reward providing condition set by the setter 122, and when it is determined that at least two of the first through fifth reward providing conditions are satisfied, generate and provide at least two same rewards and a bonus reward to the first terminal.

According to an embodiment, the reward generator and provider 123 may compare the state information received by the reward generator and provider 123 and the reward providing condition set by the setter 122, and even when the reward providing condition is satisfied, generate and provide a reward arbitrarily set by the second user from the second terminal to the first terminal, instead of a reward according to the reward providing condition. For example, the reward generator and provider 123 may compare the state information received by the state information receiver 121 and the reward providing condition set by the setter 122, and when it is determined that the first reward providing condition is satisfied, generate and provide the third reward that is arbitrarily set by the second user to the first terminal, instead of generating and providing the first reward to the first terminal.

While providing a reward to the first terminal, the reward generator and provider 123 may transmit a reward providing result notification to the first terminal. The reward generator and provider 123 may receive, according to selection of the second user, at least one transmission method setting signal based on the phone number of the first terminal, which is included in the calling route information of the second terminal, or an email address or a social network service (SNS) address included in the information about the first user, which is stored in the first storage unit 113, and transmit the reward providing result notification to the first terminal according to the at least one transmission method setting signal.

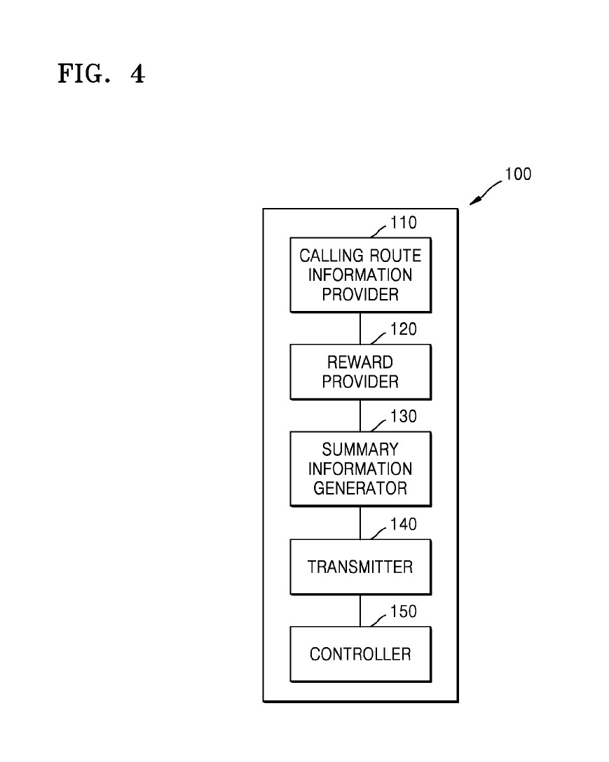

FIG. 4 is a block diagram of the system 100 for providing a reward, according to another embodiment. Details of the system 100 of FIG. 4, which overlap those of the system 100 of FIGS. 1 through 3, are not provided again. Referring to FIG. 4, the system 100 includes the calling route information provider 110, the reward provider 120, a summary information generator 130, a transmitter 140, and a controller 150.

The summary information generator 130 generates summary information by organizing a call history with the first terminal in text according to reception of a selection signal of the second terminal driven by the call signal, after the phone number link object is selected from the first terminal. Here, the summary information may be generated by an input of the second user on the second terminal, and may be stored in the second storage unit 124. For example, the summary information may include text information, such as information about a call received from first terminal, an inquiry about a location of the second user from the first user, a reservation by the first user to visit on a certain date, information about a visit by the first user on a certain date, and payment by first user on a certain date.

The summary information generator 130 may generate the summary information according to an input of the second user according to at least one of a case when the second terminal receives the call signal, a case when the telephone conversation with the first user is performed, a case when the first user makes a reservation for a visit, a case when the first user pays a visit, and a case when the first user makes a payment, and may also generate the summary information according to an input of the user after the telephone conversation with the first user is ended.

According to an embodiment, the controller 150 controls the reward provider 120 to provide a reward to the first terminal according to the generation of the summary information. In relation to the generation of the summary information, the reward provider 120 may set the reward providing condition corresponding to the generation of the summary information, and when the generation of the summary information starts or ends according to an input of the second user, generates and provides a reward corresponding to the generation of the summary information to the first terminal. Also, the reward provider 120 may set at least one transmission method based on the phone number of the first terminal, the email address of the first user, and the SNS address of the first user, and transmit a reward providing result notification to the first terminal according to the at least one transmission method.

The transmitter 140 transmits, to the first terminal, information requested by the first terminal upon receiving a selection signal of the second terminal driven by the call signal after the phone number link object is selected from the first terminal. Here, the information requested by the first terminal may include information stored in the second terminal or information input by the second user, and may be stored in the second storage unit 124. The information requested by the first terminal is information related to the second user, and may include, for example, product and service information provided by the second user, location information of the second user, event information provided by the second user, or other message information expressing, for example, gratitude.

The transmitter 140 may transmit the information requested by the first terminal to the first terminal according to at least one of a case when the second terminal receives the call signal, a case when the telephone conversation with the first user is performed, when the first user makes a reservation for a visit, a case when the first user pays a visit, and a case when the first user makes a payment.

According to an embodiment, the controller 150 controls the reward provider 120 to provide a reward to the first terminal according to a case when the first terminal requests the second terminal for a message. In relation to a message request, the reward provider 120 may set a reward providing condition corresponding to the message request, and when the first user requests a message, generate and provide a reward corresponding to the message request to the first terminal according to an input of the second user. Also, the reward provider 120 may set at least one transmission method based on the phone number of the first terminal, the email address of the first user, and the SNS address of the first user, and transmit a reward providing result notification to the first terminal according to the at least one transmission method.

According to an embodiment, the controller 150 may provide first through fifth additional functions for the second user. The first additional function may include a function enabling the second user to register and change content, text, or a drawing introducing the second user according to selection of the second user. The second additional function may include a function enabling the second user to register and change product and service information provided by the second user, location information of the second user, event information provided by the second user, or a gratitude message according to selection of the second user. The third additional function may include a function enabling the second user to store and update information about the first user (the phone number of the first terminal, a name of the first user, an email address of the first user, and the SNS address of the first user) who visited the second user according to selection of the second user. The fourth additional function may include a function enabling the second user to charge and manage a reward to be provided to the first terminal according to selection of the second user. The fifth additional function may include a function enabling the second user to register and change a reservation of the first user on a calendar according to selection of the second user. The first through fifth additional functions performed according to selection of the second user may be stored in the second storage unit 124.

The calling route information provider 110, the reward provider 120, the summary information generator 130, the transmitter 140, and the controller 150 of FIGS. 1 through 4 may include various types of devices capable of processing data, such as a processor, which manages operations of the system 100. Here, the processor may be understood as, for example, a data processing device included in hardware and including a circuit physically configured to perform a function expressed using code or instructions included in a program. Examples of the data processing device included in hardware as described above may include various processing devices such as a microprocessor, a central processing unit (CPU), a processor core, a multiprocessor, an application-specific integrated circuit (ASIC), a field programmable gate array (FPGA), etc., but embodiments are not limited thereto. The calling route information provider 110, the reward provider 120, the summary information generator 130, the transmitter 140, and the controller 150 may also be implemented as software programs, such as in an application (app), which are executed in one or more hardware devices such as a processor.

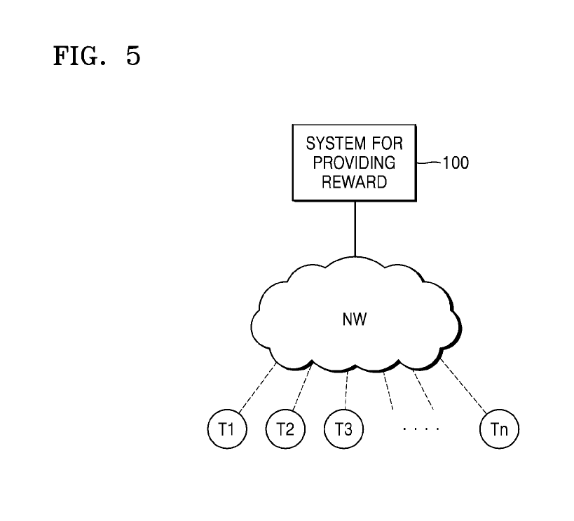

FIG. 5 is a diagram for describing a relationship between a user terminal and the system 100 of FIG. 1, according to an embodiment. Referring to FIG. 5, the system 100 may be connected to a plurality of first through n-th user terminals T1 through Tn via a network NW including a wired and/or wireless communication network such as the Internet and/or Intranet. In other words, the system 100 may be connected to the network NW while being distinguished and separated from the first through n-th user terminals T1 through Tn.

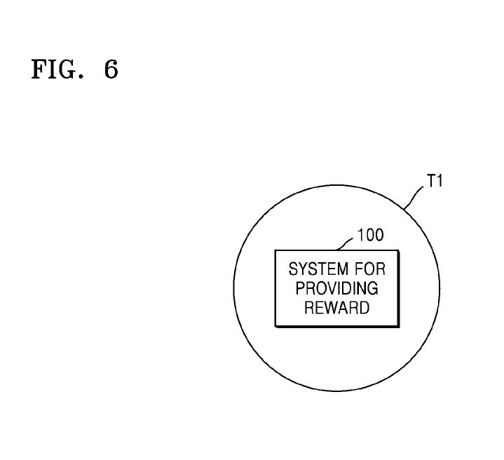

FIG. 6 is a diagram for describing a relationship between a user terminal and the system 100 of FIG. 1, according to another embodiment. Referring to FIG. 6, the system 100 may be included in the first user terminal T1. Although not illustrated, the system 100 may be included in each user terminal T1 through Tn. A method of including the system 100 according to the embodiment to the first user terminal T1 may vary. According to an embodiment, users may install the system 100 in their user terminals through the network NW, and for example, the system 100 may be installed in the first user terminal T1 in a form of an application. According to another embodiment, the system 100 may be installed in the first user terminal T1 offline. However, an embodiment is not limited thereto, and the system 100 may be installed in the first user terminal T1 in any form. Here, the first user terminal T1 may be the second terminal, and the user may be the second user.

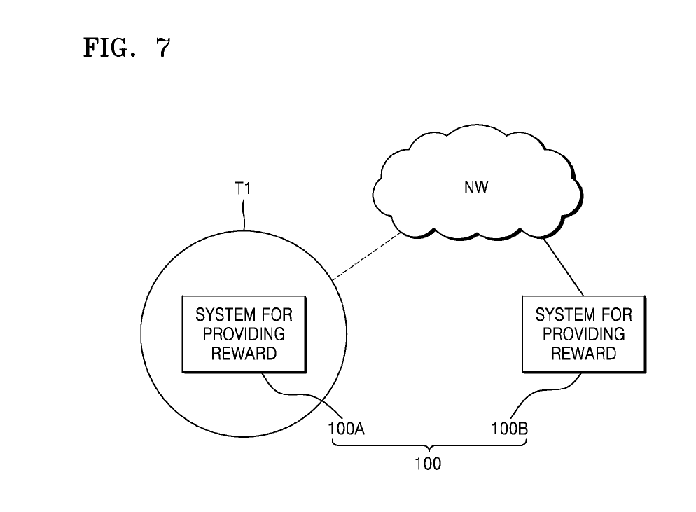

FIG. 7 is a diagram for describing a relationship between a user terminal and the system 100 of FIG. 1, according to another embodiment. Referring to FIG. 7, a part 100A of the system 100 may be included in the first user terminal T1 and another part 100B of the system 100 may be connected to the first user terminal T1 through the network NW. Here, the first user terminal T1 may be the second terminal and a user may be the second user.

For example, the part 100A including the calling route information provider 110 and the reward provider 120 of the system 100 may be included in the first user terminal T1. Since a method of including the part 100A of the system 100 to the first user terminal T1 has been described above with reference to FIG. 7, details thereof will not be provided again. Also, the other part 100B including the summary information generator 130, the transmitter 140, and the controller 150 of the system 100 may be connected to the first user terminal T1 through the network NW.

According to the current embodiment, the summary information generator 130, the transmitter 140, and the controller 150 of the system 100, which constitute the other part 100B, are connected to the first user terminal T1 through the network NW, but an embodiment is not limited thereto. In other words, at least one of a plurality of elements included in the system 100 may be selectively connected to the first user terminal T1 through the network NW.

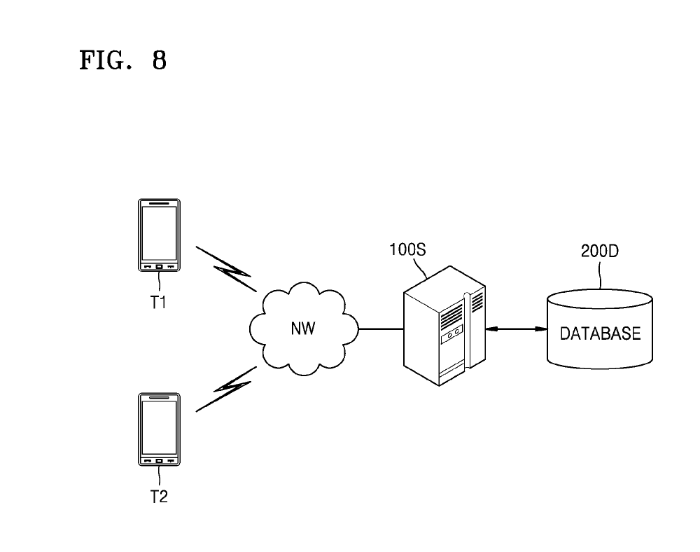

FIG. 8 is a diagram of a system for providing a reward, according to another embodiment. Details overlapping those described above with reference to FIGS. 1 through 7 will not be provided again. Referring to FIG. 8, the system is realized as a server 100S providing a reward, and the first and second user terminals T1 and T2 are connected to the server 100S through the network NW. Information stored in the first and second storage units 113 and 124 described above are stored in a database 200D.

The server 100S provides a call connection between the first and second user terminals T1 and T2 according to a phone number link object selection signal on a web page displayed on the first user terminal T1.

The server 100S compares first call information related to the first user terminal T1 according to the phone number link object selection signal on the web page displayed on the first user terminal T1 and second call information related to a call signal from the second user terminal T2 driven according to the phone number link object selection signal, and displays some (calling route information) of the first call information on the second user terminal T2 based on a result of matching the phone number link object selection signal and the call signal.

The server 100S compares state information of the first user terminal T1, which is received from the second user terminal T2 driven according to the call signal, and a reward providing condition, and provides a reward that is accumulable to the first user terminal T1 satisfying the reward providing condition.

The server 100S generates summary information by organizing a call history with respect to the first user terminal T1 upon receiving a selection signal of the second user terminal T2 driven according to the call signal, after a phone number link object is selected from the first user terminal T1. Here, the summary information may be generated by an input of the second user on the second user terminal T2 and transmitted to the server 100S. The server 100S provides the reward to the first user terminal T1 according to the generation of the summary information.

The server 100S transmits information requested by the first user terminal T1 to the first user terminal T1 upon receiving a selection signal of the second user terminal T2 driven according to the call signal, after the phone number link object is selected from the first user terminal T1. The server 100S provides the reward to the first user terminal T1 when the first user terminal T1 requests the second user terminal T2 for a message.

The server 100S sets at least one transmission method based on a phone number of the first user terminal T1, an email address of the first user, and an SNS address of the first user, and transmit a reward providing result notification to the first user terminal T1 based on the at least one transmission method.

The server 100S may provide first through fifth additional functions for the second user terminal T2.

FIGS. 9A through 9D illustrate an example of information-related screens provided by the system 100 to the first and second user terminals T1 and T2, according to an embodiment.

FIG. 9A illustrates a search screen displayed on the first user terminal T1, and for example, the search screen about <Bundang restaurant> is displayed as the first user input <Bundang restaurant> as a search word. In the search screen, phone number links 910 and 930 corresponding to search results are shown, wherein reward identifiers 911 and 931 are displayed at the phone number link objects 910 and 930 together with a reward providing condition. By showing the reward providing condition, a probability of the first user selecting the phone number link object 910 or 930 may increase.

FIG. 9B illustrates a phone number input window of the first user terminal T1, in which <031-786-0708> is displayed as the selected phone number link object 910 on the search screen of FIG. 9A.

FIG. 9C illustrates a screen of the first user terminal T1 calling the second user terminal T2 after the first user touches a call button 960 on the phone number input window of FIG. 9B.

FIG. 9D illustrates a screen of the second user terminal T2, which is displayed before a call is connected with the first user terminal T1. The screen of the second user terminal T2 displays information including some or part of the first call information of the first user terminal T1 (for example, a phone number 010-3783-XXXX) and calling route information processed based on the first call information.

As shown in FIGS. 9A through 9C, a call is not directly connected by selecting the phone number link object 910, but the screen of FIG. 9D may be displayed through FIGS. 9B and 9C. While the first user terminal T1 displays the screens of FIGS. 9B and 9C, the system 100 collects the first call information and second call information, and determines whether the first call information and the second call information match each other.

According to an embodiment, the screen of FIG. 9D may include a summary information generating user interface (UI) 970, a message transmitting UI 980, and a reward providing UI 990.

The summary information generating UI 970 may be provided to the second user terminal T2 such that the second user may input state information of the first user terminal T1 (for example, information about the call from the first user terminal T1) before connecting the call with the first user terminal T1. When the second user selects the summary information generating UI 970, a screen for inputting summary information is displayed on the second user terminal T2, and the second user may input summary information about the first user terminal T1.

The message transmitting UI 980 may be provided to the second user terminal T2 such that the second user may input and transmit arbitrary information to the first user terminal T1 before connecting the call with the first user terminal T1. Here, the arbitrary information may include product and service information provided by the second user, location information of the second user, event information provided by the second user, or a gratitude message. When the second user selects the message transmitting UI 980, a screen for inputting and transmitting a message is displayed on the second user terminal T2, and the second user may transmit the arbitrary information to the first user terminal T1.

The reward providing UI 990 may be provided to the second user terminal T2 such that the second user may immediately provide a reward to the first user terminal T1 before connecting the call with the first user terminal T1. When the reward providing UI 990 is selected by the second user, a screen for providing a reward may be displayed on the second user terminal T2 to select and transmit a reward, or a first reward may be provided to the first user terminal T1 having first state information.

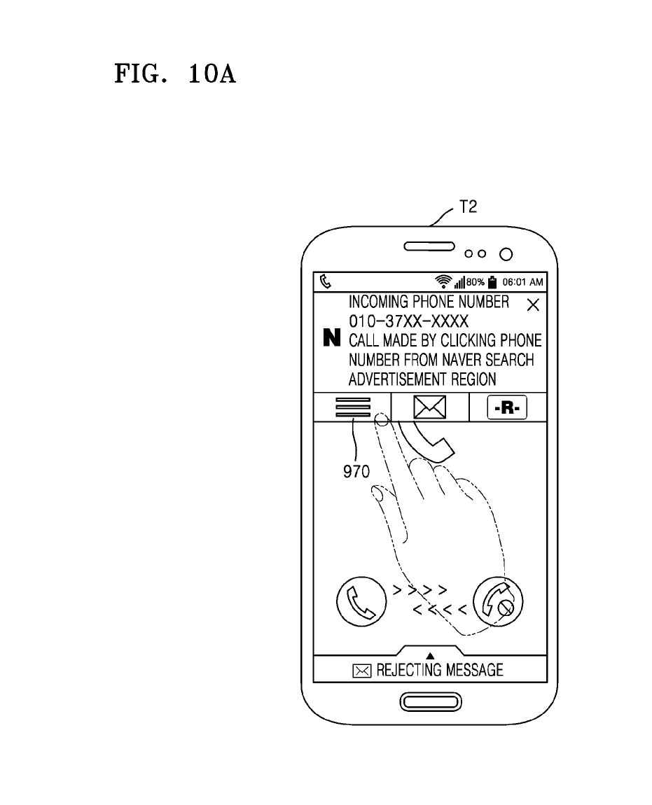

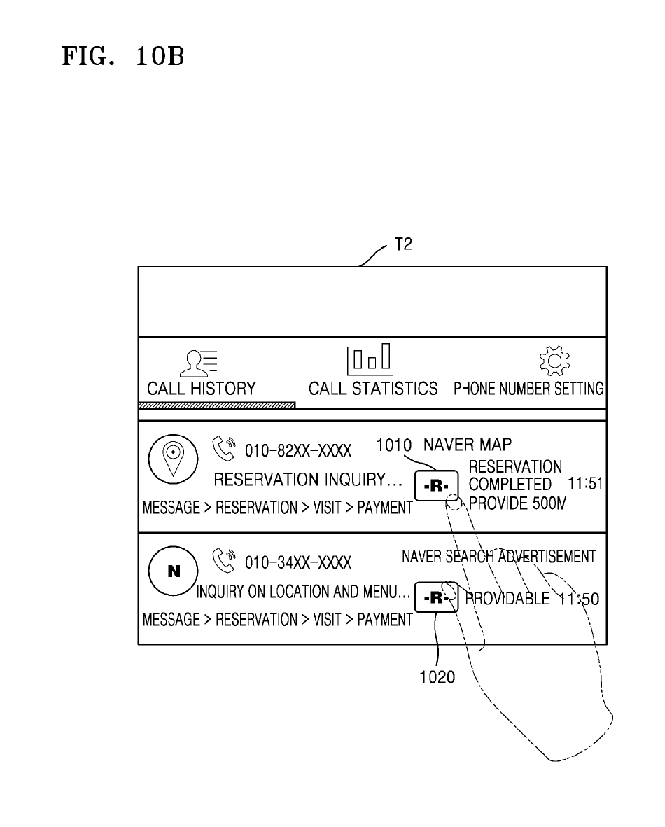

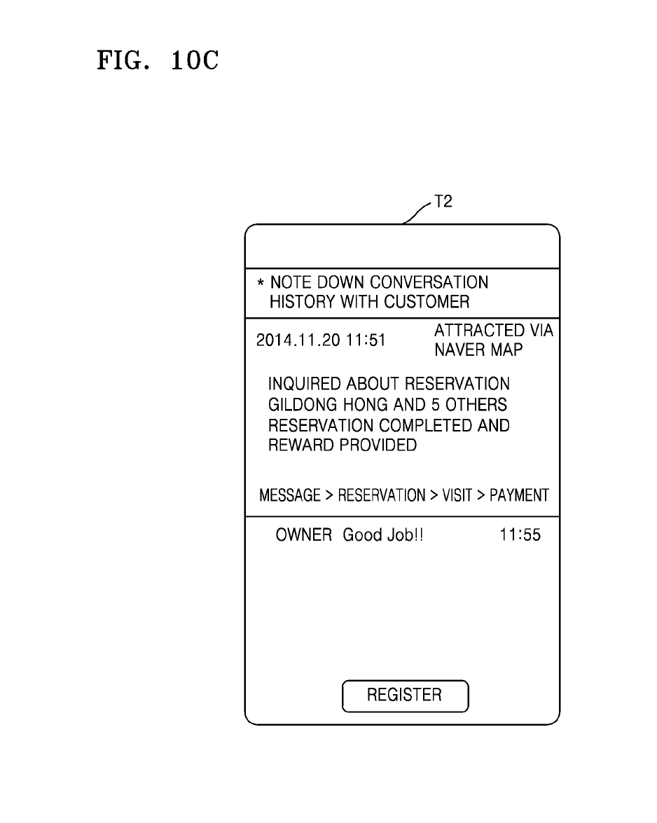

FIGS. 10A through 10C illustrate an example of information-related screens provided by the system 100 to the second user terminal T2, according to an embodiment.

Referring to FIG. 10A, before a call is connected with the first user terminal T1, the summary information generating UI 970 displayed on the second user terminal T2 is selected such that the second user may input the state information of the first user terminal T1.

FIG. 10B illustrates call history displayed on the second user terminal T2 after the call is connected with the first user terminal T1. The call history displayed on the second user terminal T2 includes information including some or part of the first call information of the first user terminal T1 and the calling route information processed based on the first call information, and the state information of the first user terminal T1, a reward identifier (1010 or 1020), and information about providing of a reward according to the state information of the first user terminal T1 may also be displayed.

FIG. 10C illustrates a summary information generating screen for generating summary information according to selection on the summary information generating UI 970 of FIG. 10A or selection of the state information of the first user terminal T1 or the reward identifier of FIG. 10B. In the summary information generating screen, when summary information is displayed in a form of a timeline, certain summary information about the first user terminal T1 may be input according to input of the second user.

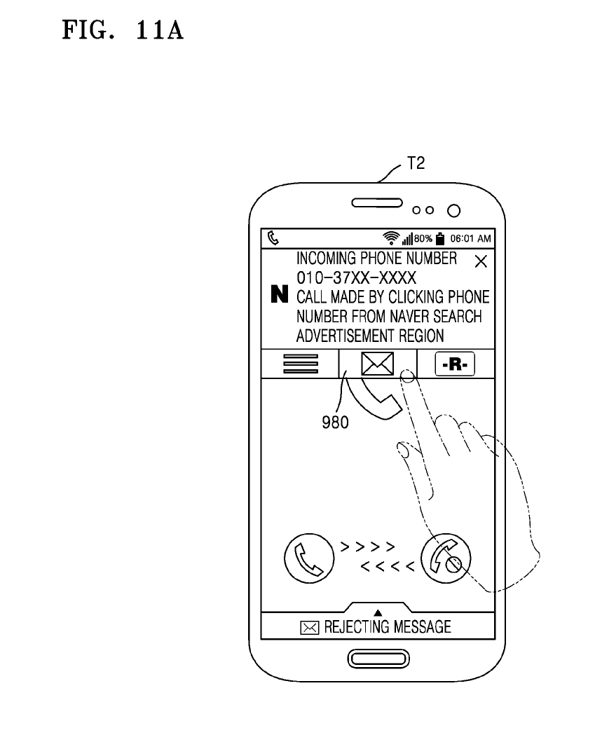

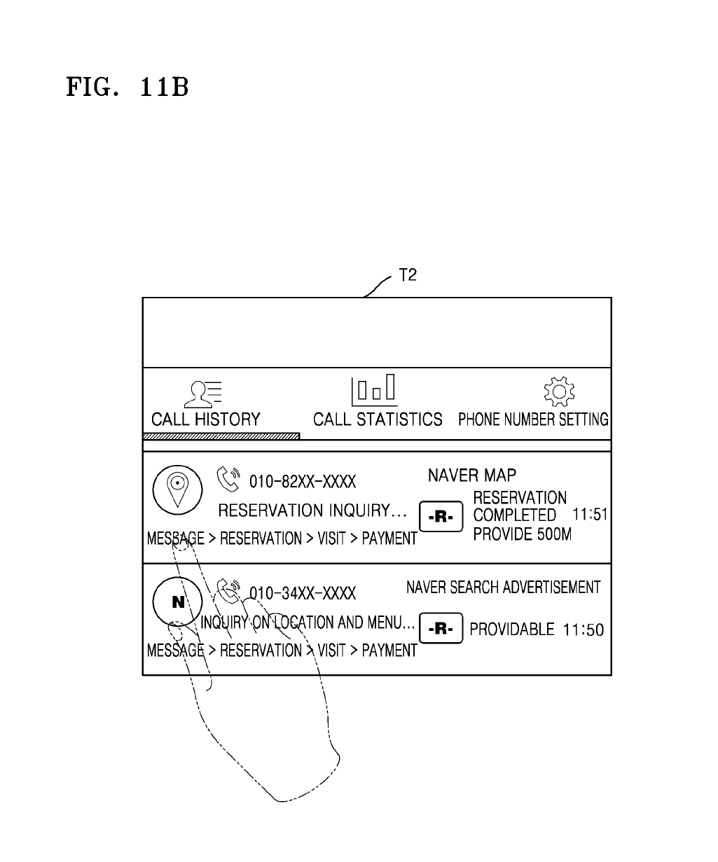

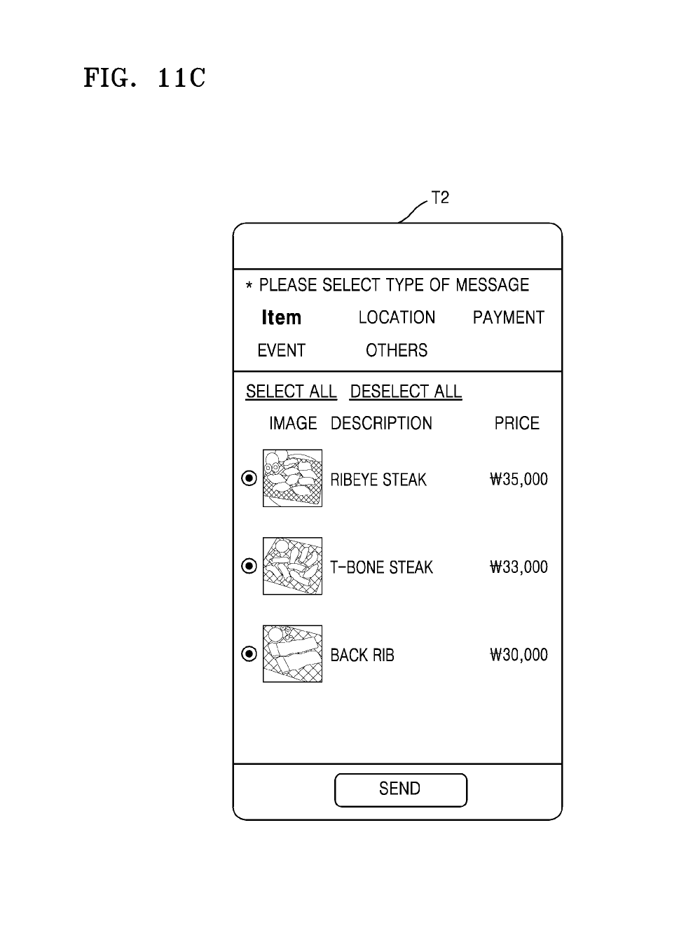

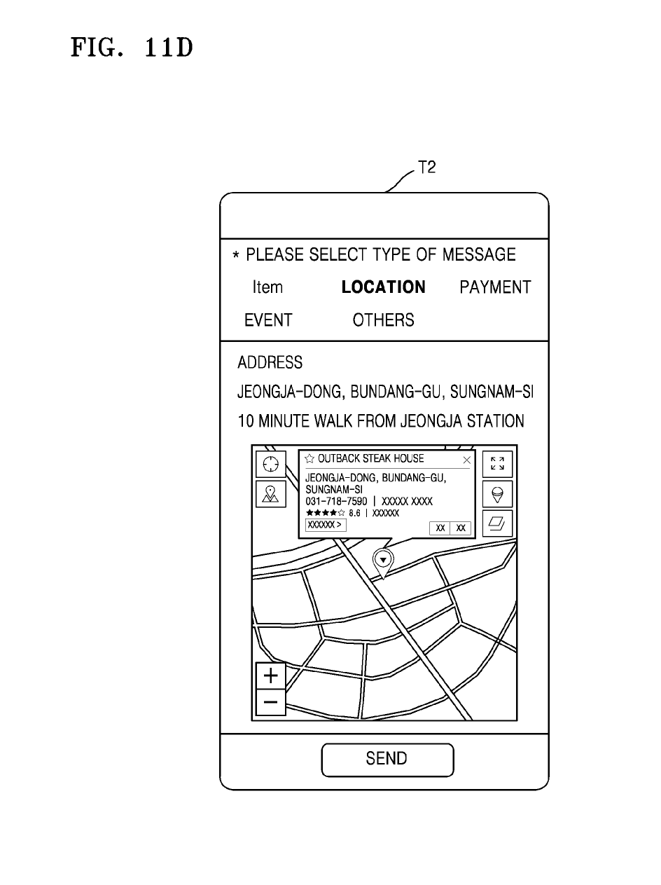

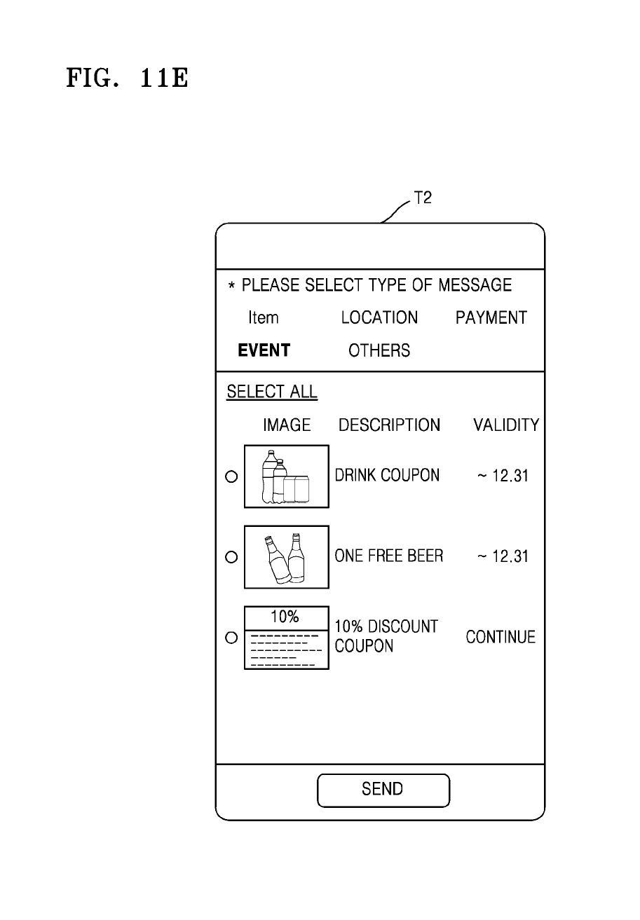

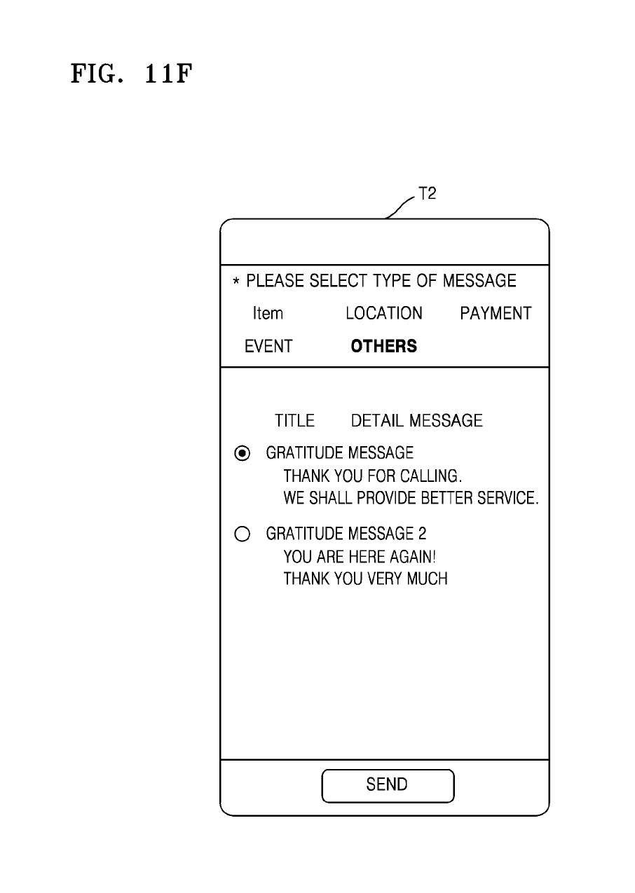

FIGS. 11A through 11F illustrate an example of information-related screens provided by the system 100 to the second user terminal T2, according to another embodiment.

Referring to FIG. 11A, before the call is connected with the first user terminal T1, the message transmitting UI 980 displayed on the second user terminal T2 is selected for the second user to transmit arbitrary information or message to the first user terminal T1.

FIG. 11B illustrates a call history displayed on the second user terminal T2 after the call is connected with the first user terminal T1. The call history displayed on the second user terminal T2 includes information including some of the first call information of the first user terminal T1 and the calling route information processed based on the first call information, and the state information of the first user terminal T1, a reward identifier, and information about providing of a reward according to the state information of the first user terminal T1 may also be displayed.

FIGS. 11C through 11F illustrate information providable to the first user terminal T1 according to selection on the message transmitting UI 980 of FIG. 11A or selection of the state information of the first user terminal T1 or the reward identifier of FIG. 11B. FIG. 11C illustrates product and service information provided by the second user, FIG. 11D illustrates location information of the second user, FIG. 11E illustrates event information provided by the second user, and FIG. 11F illustrates a gratitude message, and at least one of information shown in FIGS. 11C through 11F may be transmitted to the first user terminal T1.

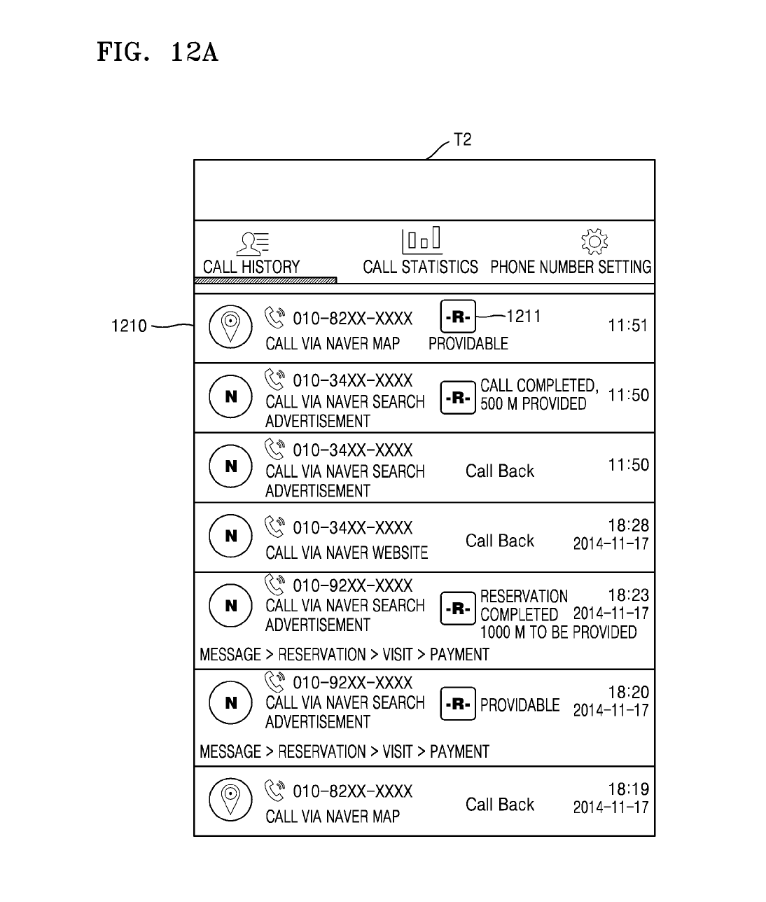

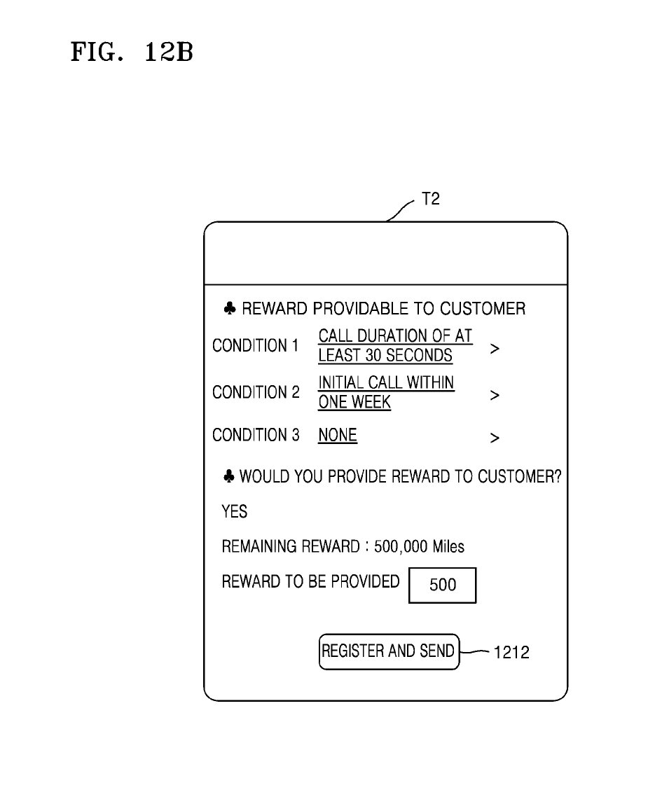

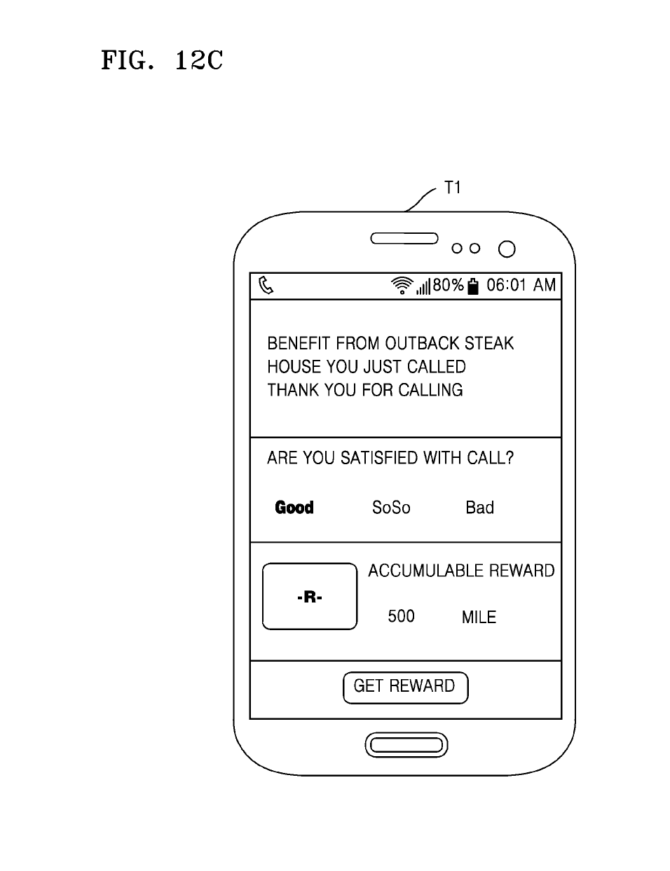

FIGS. 12A through 12C illustrate an example of information-related screens provided by the system 100 to the second user terminal T1, according to another embodiment.

FIG. 12A illustrates the call history displayed on the second user terminal T2. The call history displayed on the second user terminal T2 includes information including some of the first call information of the first user terminal T1 and the calling route information processed based on the first call information, and the state information of the first user terminal T1, a reward identifier, and information about providing of a reward according to the state information of the first user terminal T1 may also be displayed.

FIG. 12B illustrates a reward providing screen displayed on the second user terminal T2 according to selection of a reward identifier 1211 included in a first call history 1210 of FIG. 12A. The first call history 1210 shows that the first user terminal T1 has second state information according to the call between the first and second user terminals T1 and T2, and shows a reward providing condition providable according to the second state information and a generated reward. Upon receiving a selection of a register and send button 1212, the system 100 may provide the reward to the first user terminal T1.

FIG. 12C illustrates that at least one transmission method based on the phone number of the first user terminal T1, the email address of the first user, and the SNS address of the first user is set, and a reward providing result notification is transmitted to the first user terminal T1 according to the at least one transmission method. Here, the first user terminal T1 may input and transmit a review of a service provided by the second user to the system 100, and the system 100 may evaluate the second user based on the review.

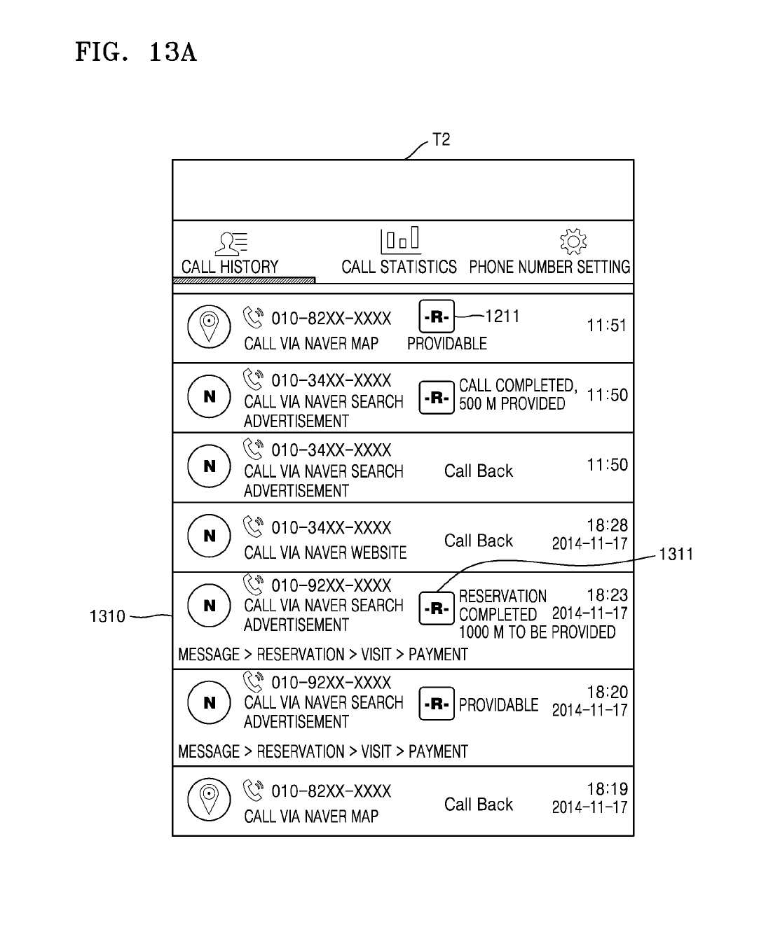

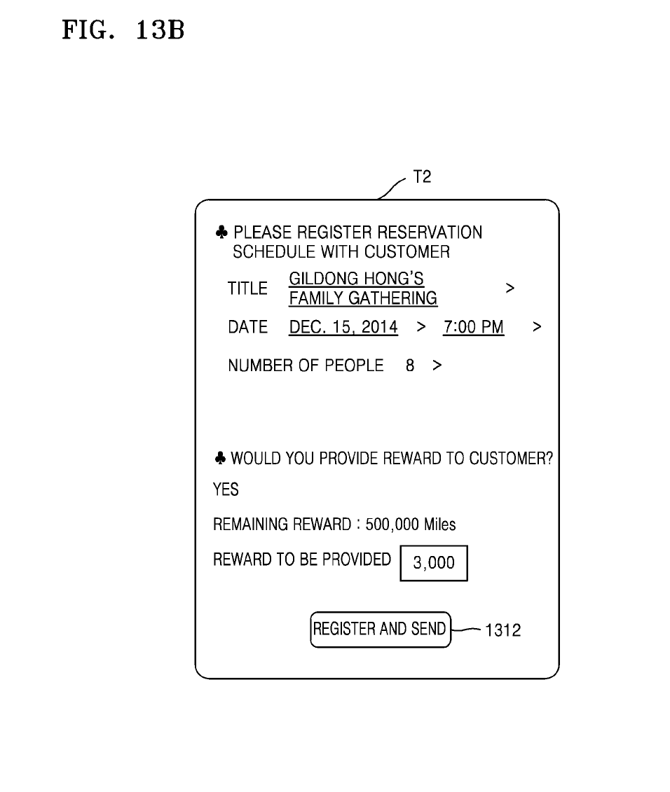

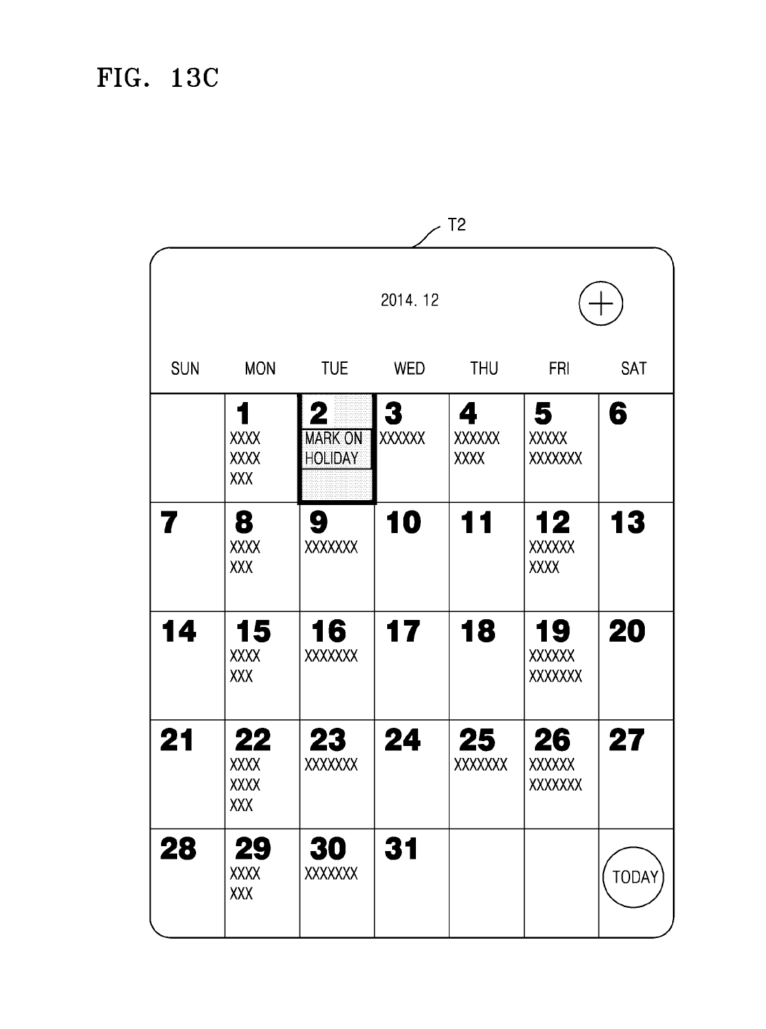

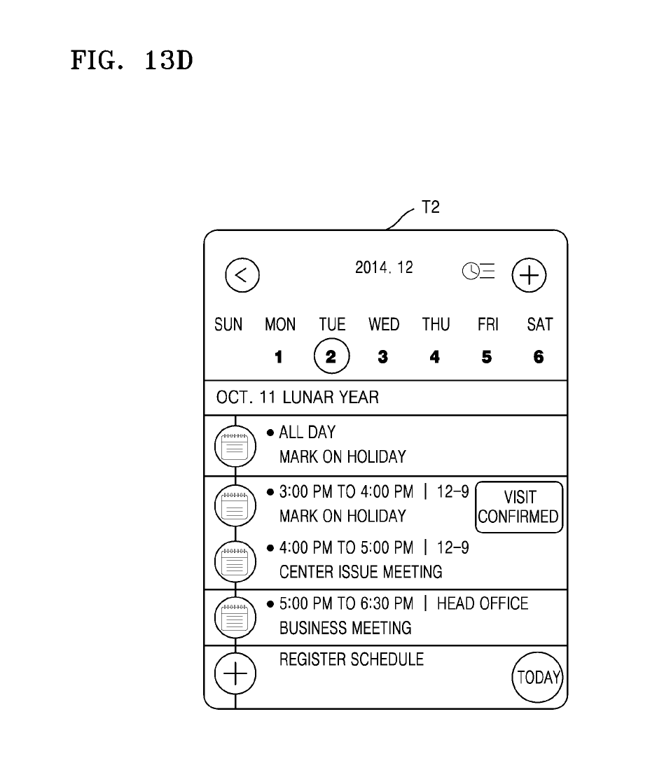

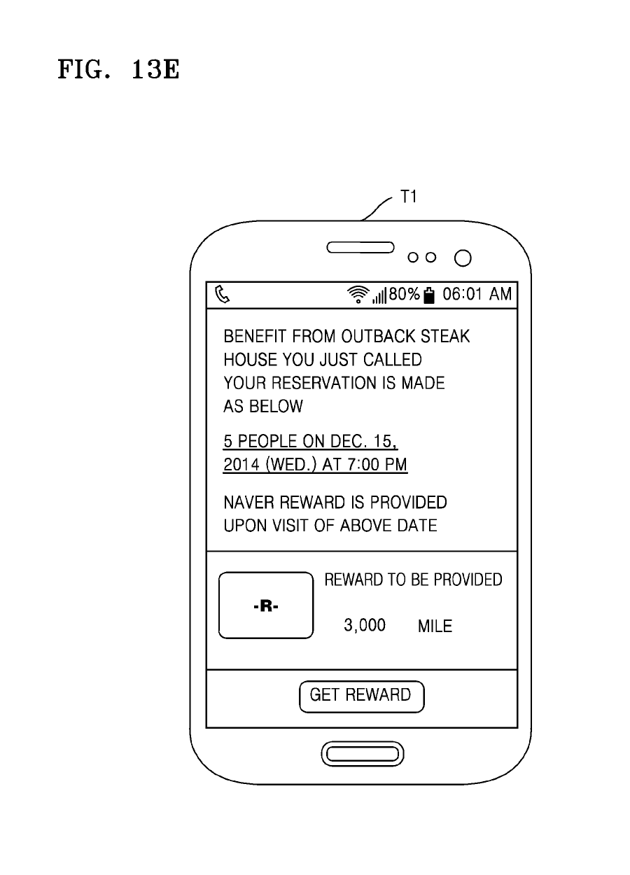

FIGS. 13A through 13E illustrate an example of information-related screens provided by the system 100 to the second user terminal T2, according to another embodiment.

FIG. 13A illustrates the call history displayed on the second user terminal T2. The call history displayed on the second user terminal T2 includes information including some of the first call information of the first user terminal T1 and the calling route information processed based on the first call information, and the state information of the first user terminal T1, a reward identifier, and information about providing of a reward according to the state information of the first user terminal T1 may also be displayed.

FIG. 13B illustrates a reservation and reward providing screen displayed on the second user terminal T2 according to selection on a reward identifier 1311 included in a second call history 1310 of FIG. 13A. In the second call history 1310, the first user terminal T1 has third state information according to the call between the first and second user terminals T1 and T2, and a reward providing condition providable according to the third state information, a reservation title, a reservation date, a number of people, and a generated reward.

FIG. 13C illustrates a calendar displayed on the second user terminal T2 according to an input on a register and send button 1312. The calendar may display a reservation of the first user, which is input by the second user.

FIG. 13D illustrates other reservations on a date the first user made a reservation in a form of a timeline, according to selection by the second user of the date (for example, Dec. 2, 2014) the first user made the reservation. The second user may register the reservation of the first user at a time the first user made the reservation.

FIG. 13E illustrates that at least one transmission method based on the phone number of the first user terminal T1, the email address of the first user, and the SNS address of the first user is set, and a reward providing result notification and the reservation are transmitted to the first user terminal T1 according to the at least one transmission method. Here, the first user terminal T1 may input and transmit a review on service provided by the second user to the system 100, and the system 100 may evaluate the second user based on the review.

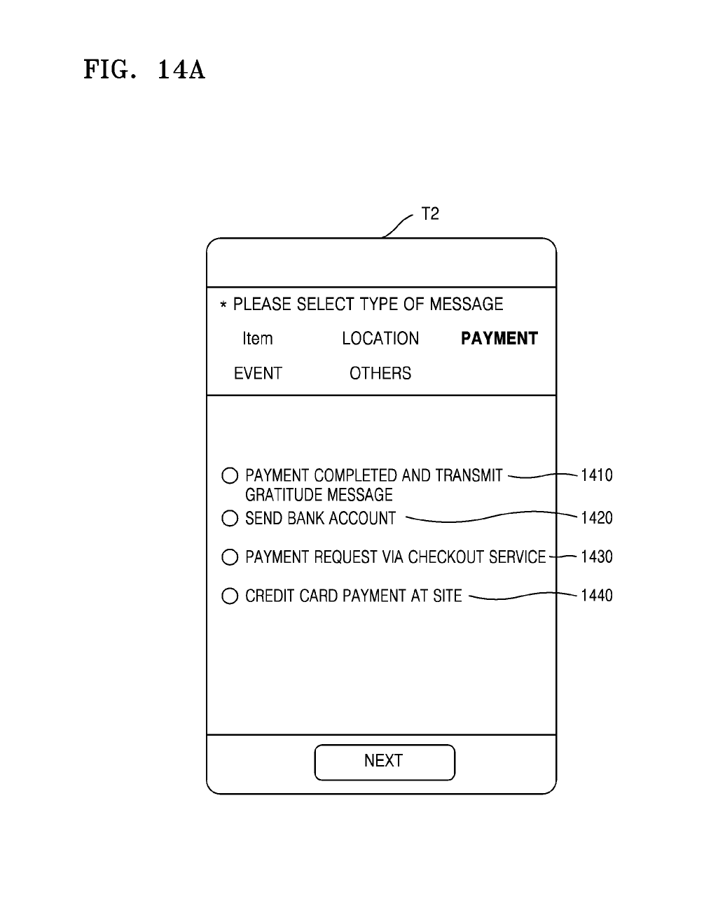

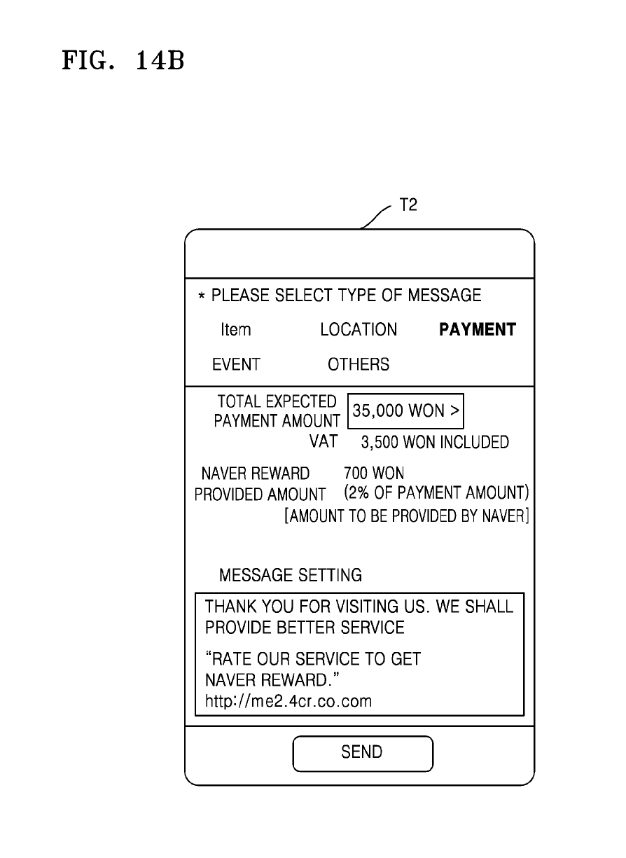

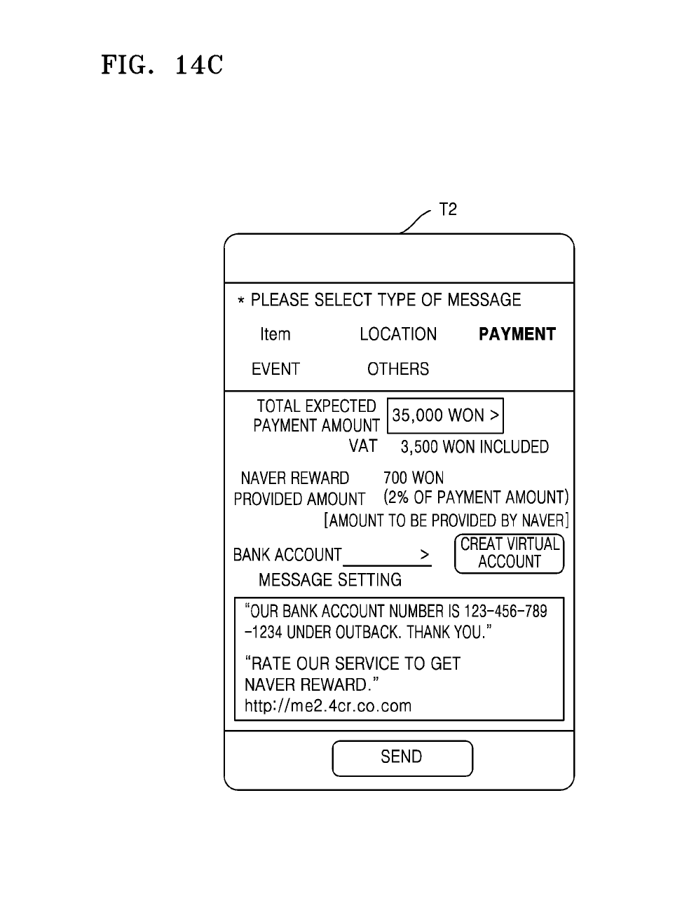

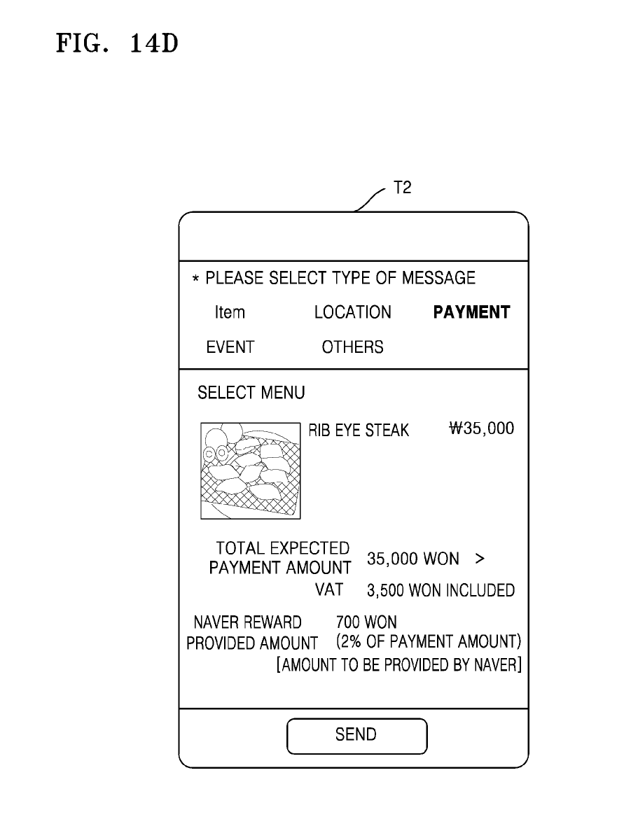

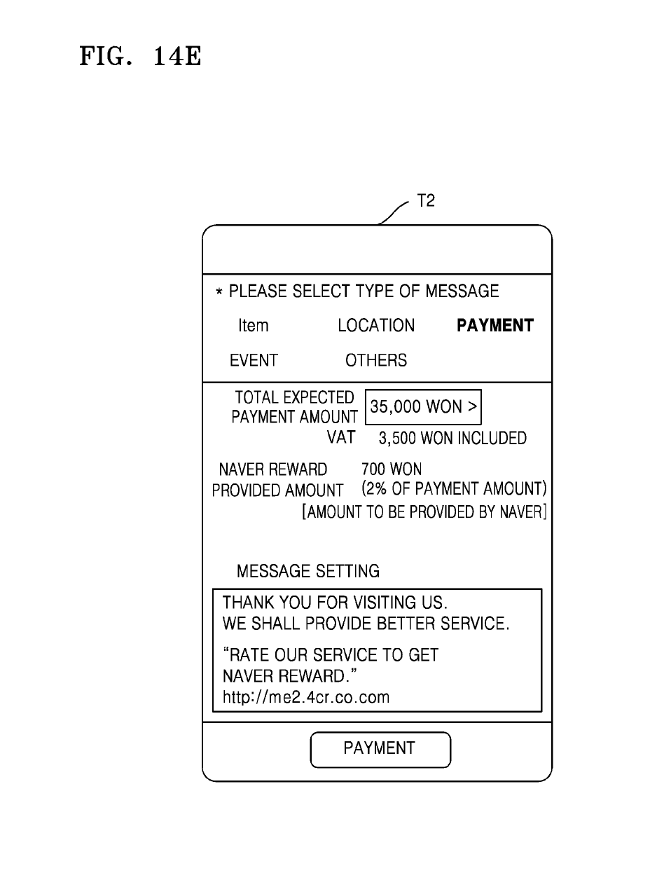

FIGS. 14A through 14E illustrate an example of information-related screens provided by the system 100 to the second user terminal T2, according to another embodiment.

FIG. 14A illustrates a payment type of the first user terminal T1 or the first user in order to provide a reward to the first user terminal T1. The payment type includes a first payment type 1410 to a fourth payment type 1440, and may be selected by the second user. The first payment type 1410 may include a case in which the first user has completed a payment and a reward and a gratitude message are transmitted to the first user. The second payment type 1420 may include a bank account and a payment amount, together with a reward to be provided when a payment is completed. The third payment type 1430 may include a payment using a Checkout service and a reward to be provided. The fourth payment type 1440 may include a credit card payment at the site using a card reader and a reward to be provided.

FIG. 14B illustrates a message about payment completion, a reward, and gratitude to be transmitted to the first user terminal T1 when the second user selects the first payment type 1410. FIG. 14C illustrates a message about a bank account, a payment amount, and a reward to be provided to be transmitted to the first user terminal T1 when the second user selects the second payment type 1420. FIG. 14D illustrates a message about a payment using a Checkout service and a reward to be provided to be transmitted to the first user terminal T1 when the second user selects the third payment type 1430. FIG. 14E illustrates a message about a credit card payment at the site and a reward to be provided to be transmitted to the first user terminal T1 when the second user selects the fourth payment type 1440.

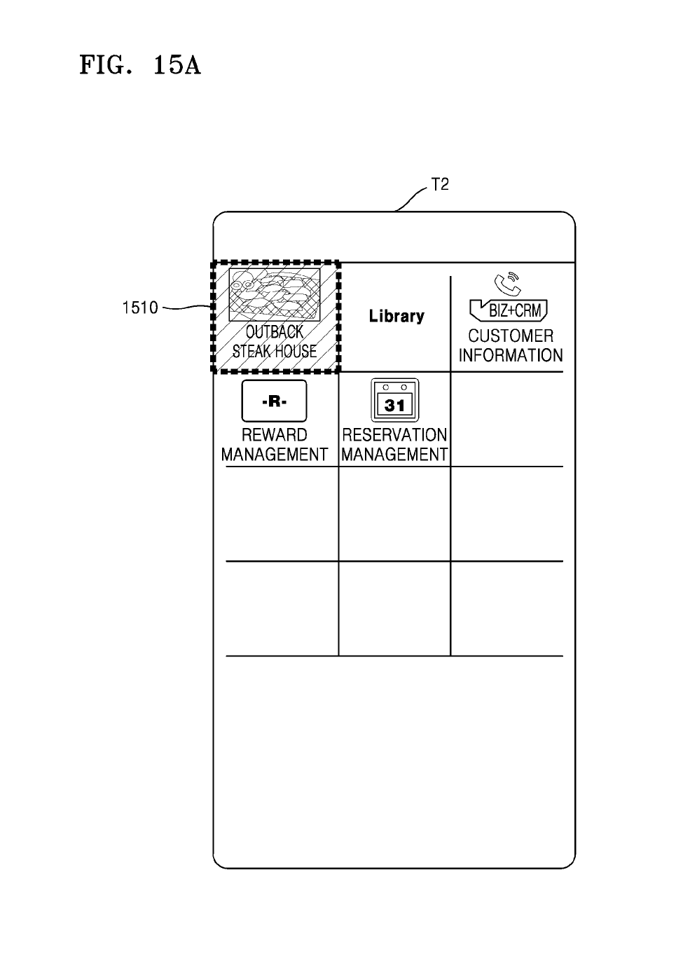

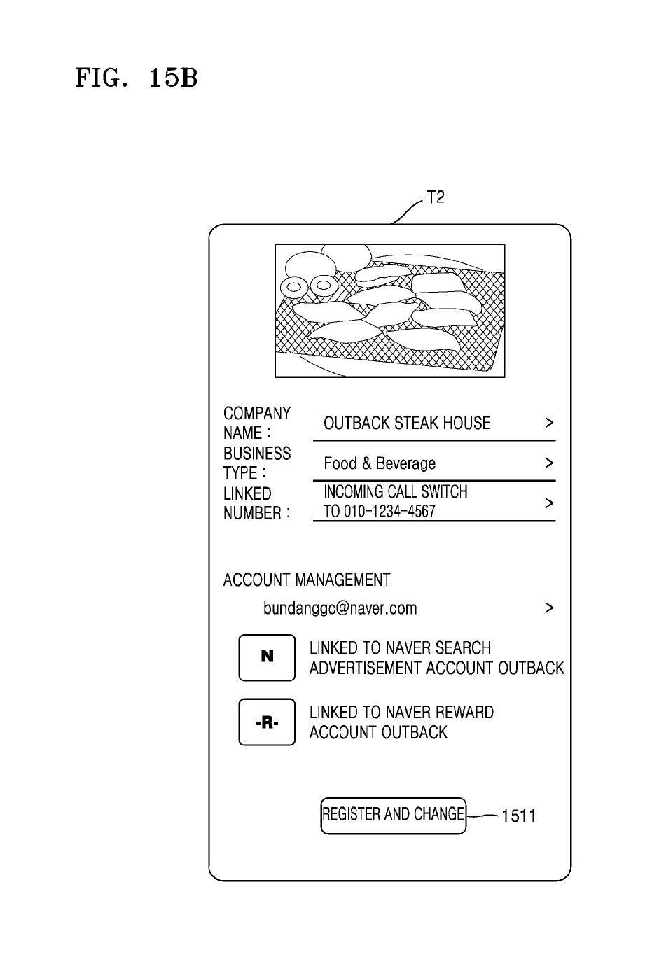

FIGS. 15A through 19B illustrate examples of information-related screens provided by the system 100 to the second user terminal T2, according to other embodiments.

FIG. 15A illustrates a screen in which a first additional function 1510 is selected from among first through fifth additional functions 1510 through 1550 provided to the second user terminal T2 from the system 100. The first additional function 1510 may include a function enabling the second user to register and change content, text, and a drawing introducing the second user.

FIG. 15B illustrates the content, the text, and the drawing introducing the second user displayed on the second user terminal T2, which may be registered or changed when a registering and changing UI 1511 is selected. The system 100 changes the content, the text, and the drawing introducing the second user to the desired content, the desired text, and the desired drawing introducing the second user.

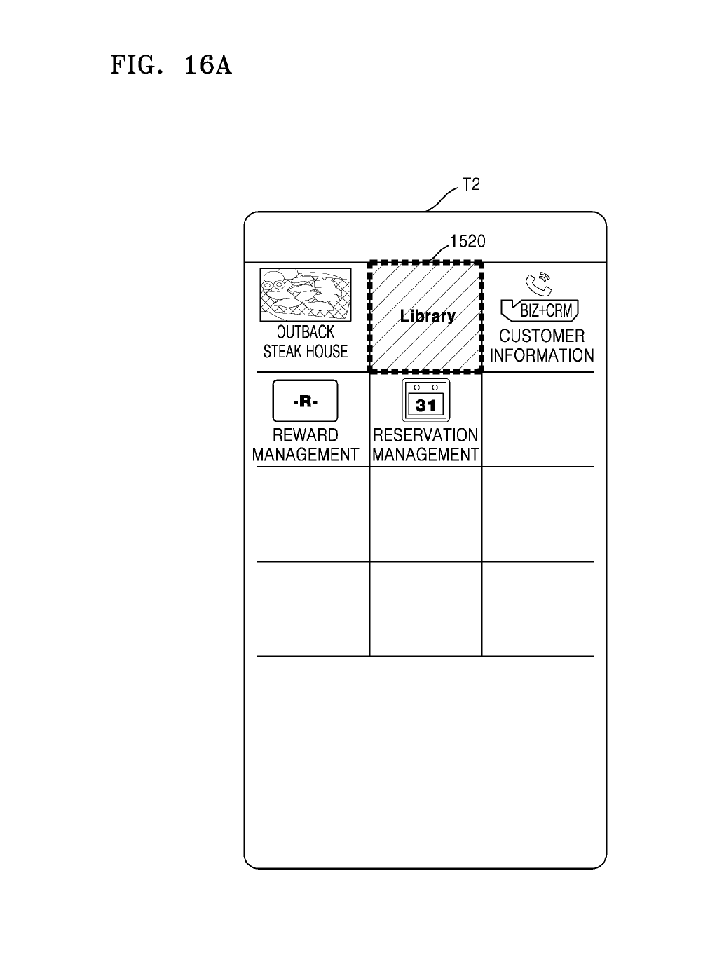

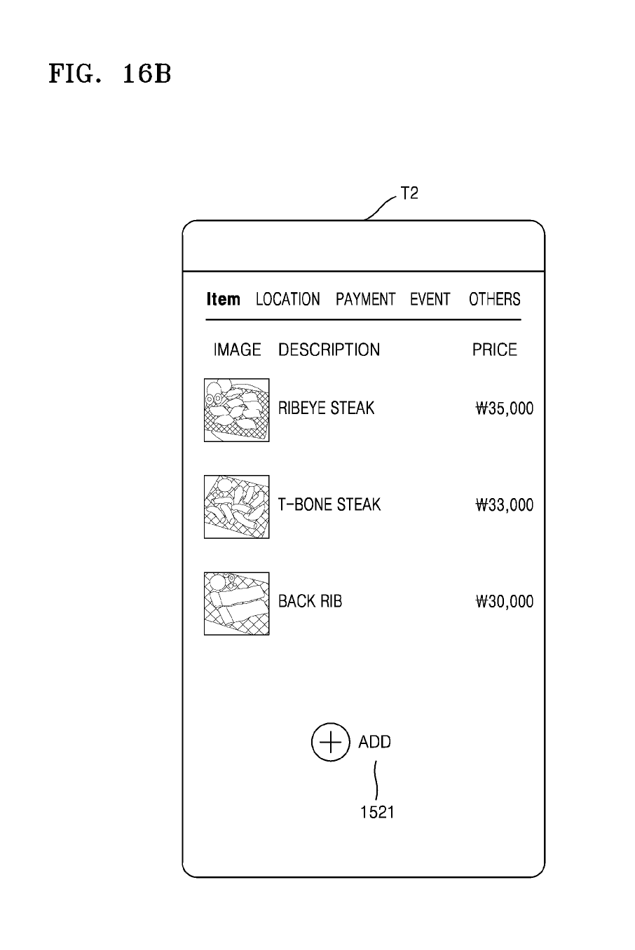

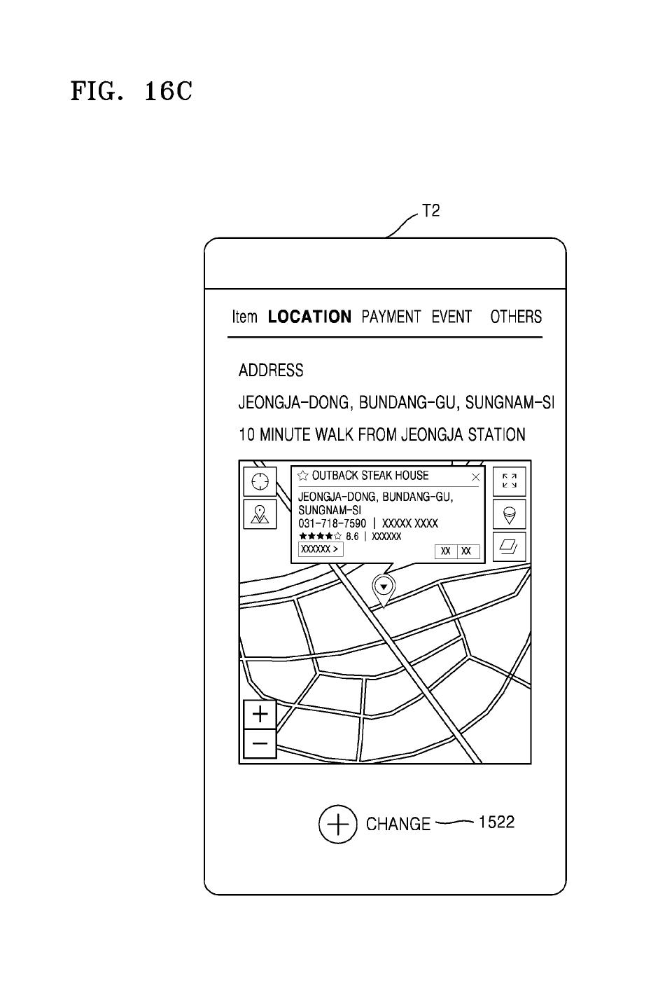

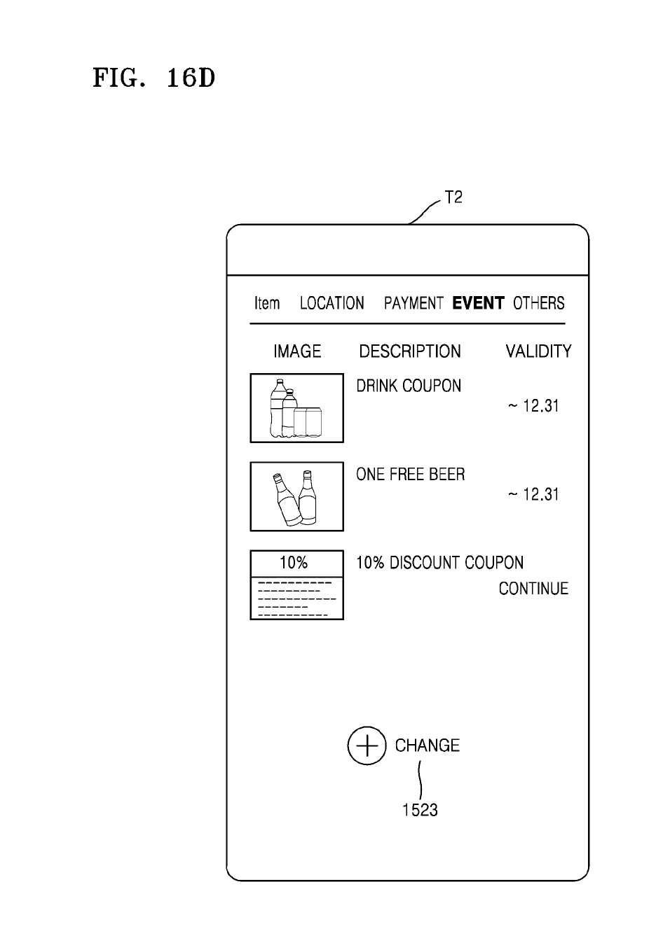

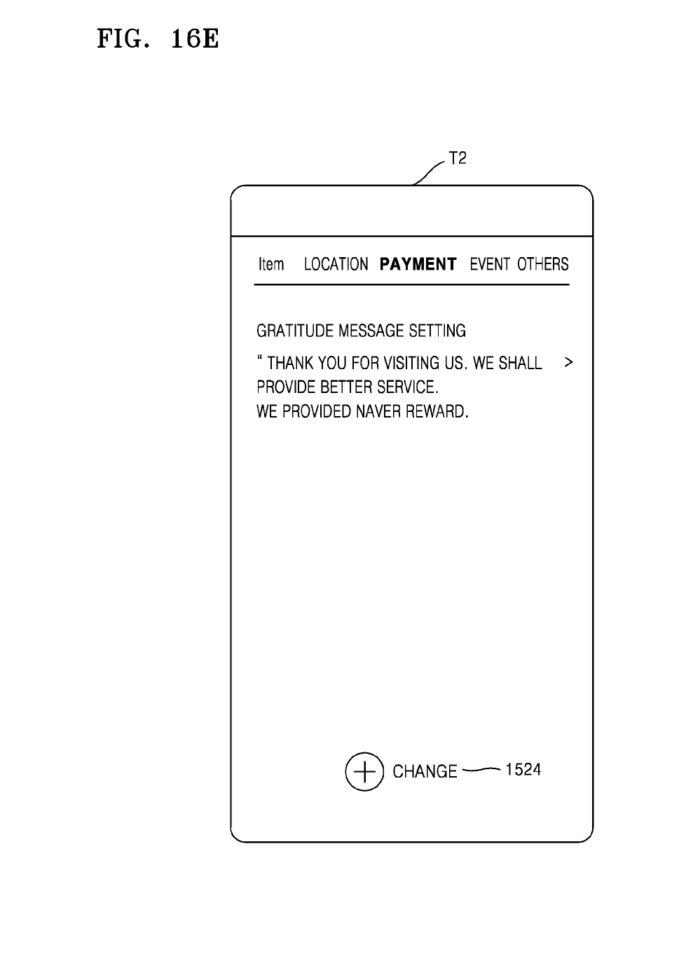

FIG. 16A illustrates a screen in which the second additional function 1520 is selected from among the first through fifth additional functions 1510 through 1550 provided to the second user terminal T2 from the system 100. The second additional function 1520 may include a function enabling the second user to register and change product and service information provided by the second user, location information of the second user, a gratitude message according to payment completion, or event information provided by the second user.

FIG. 16B illustrates the product and service information provided by the second user displayed on the second user terminal T2, and content may be added to the product and service information by selecting an adding UI 1521. FIG. 16C illustrates the location information of the second user displayed on the second user terminal T2, and content of the location information may be changed by selecting a changing UI 1522. FIG. 16E illustrates the gratitude message transmitted to the first user who completed a payment displayed on the second user terminal T2, and content of the gratitude message may be changed by selecting a changing UI 1523. FIG. 16D illustrates the event information provided from the second user to the first user displayed on the second user terminal T2, and content of the event information may be changed by selecting a changing UI 1524.

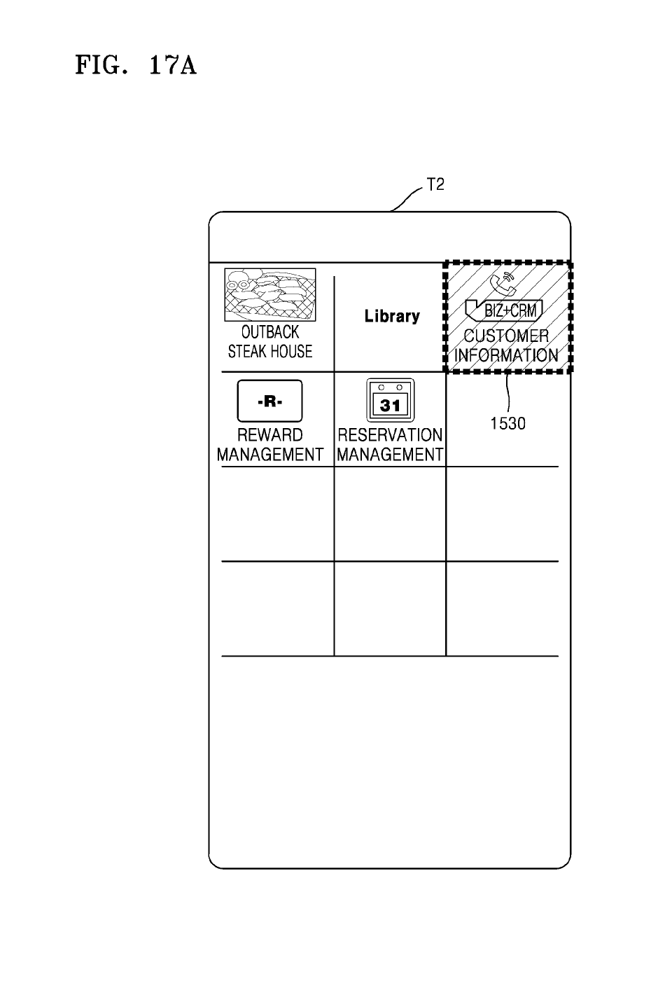

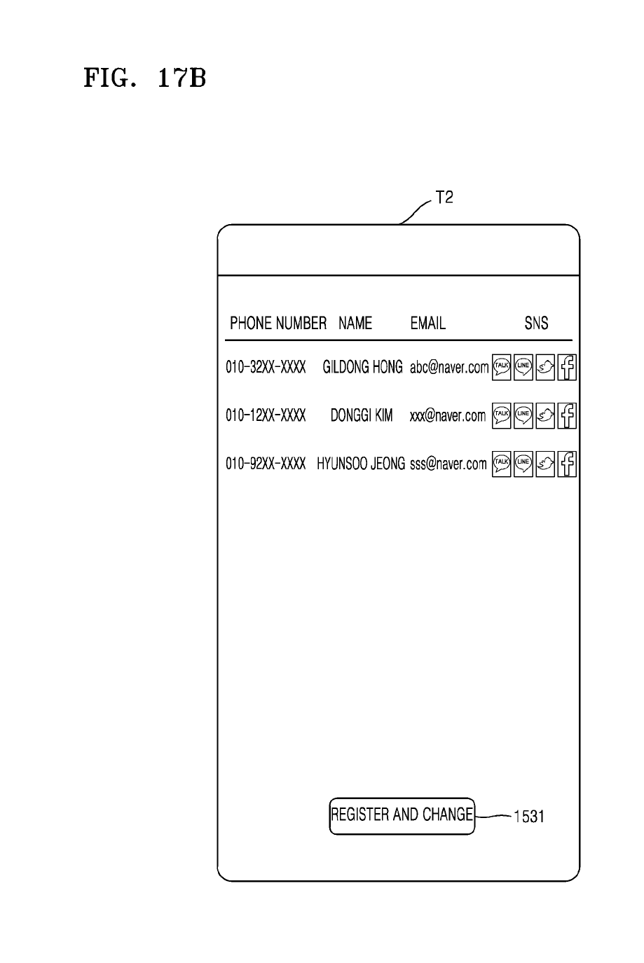

FIG. 17A illustrates a screen in which the third additional function 1530 is selected from among the first through fifth additional functions 1510 through 1550 provided to the second user terminal T2 by the system 100. The third additional function 1530 may include a function enabling the second user to store and update information about the first user (the phone number of the first user terminal T1, the name, the email address, and the SNS address of the first user) who visited the second user.

FIG. 17B illustrates the information about the first user displayed on the second user terminal T2, and the information may be newly registered or content of the information may be changed when a registering and changing UI 1531 is selected.

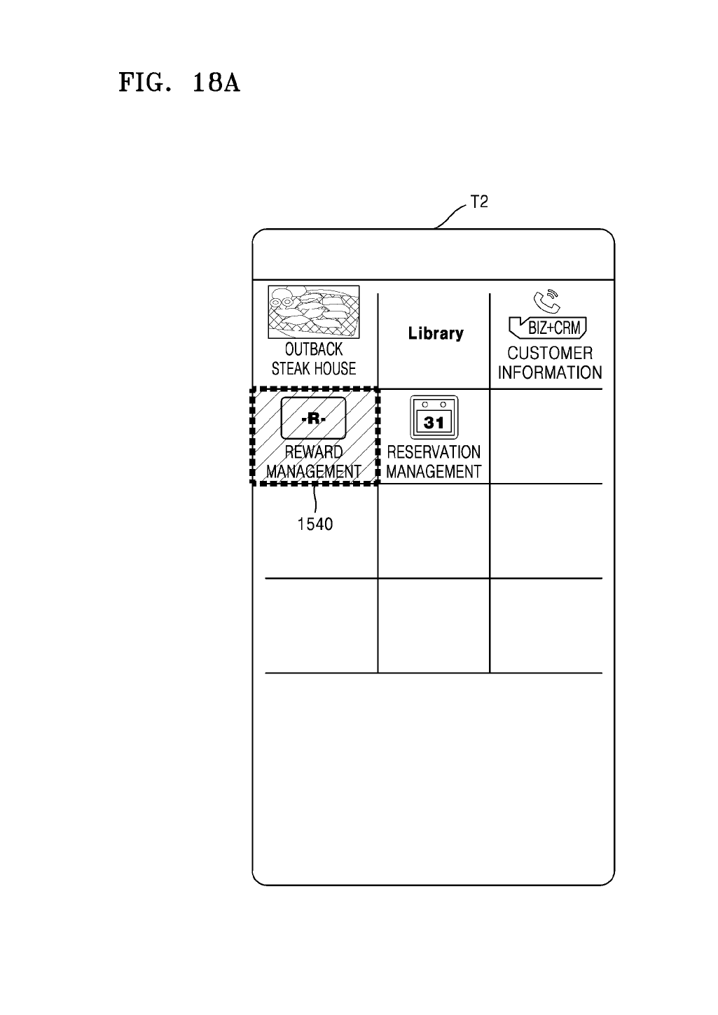

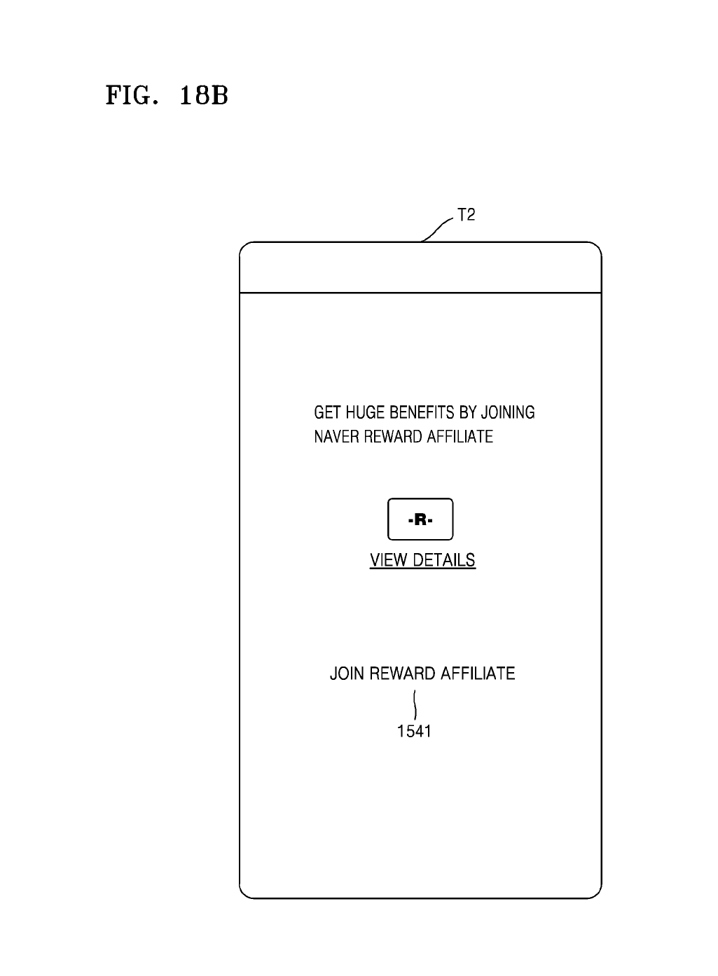

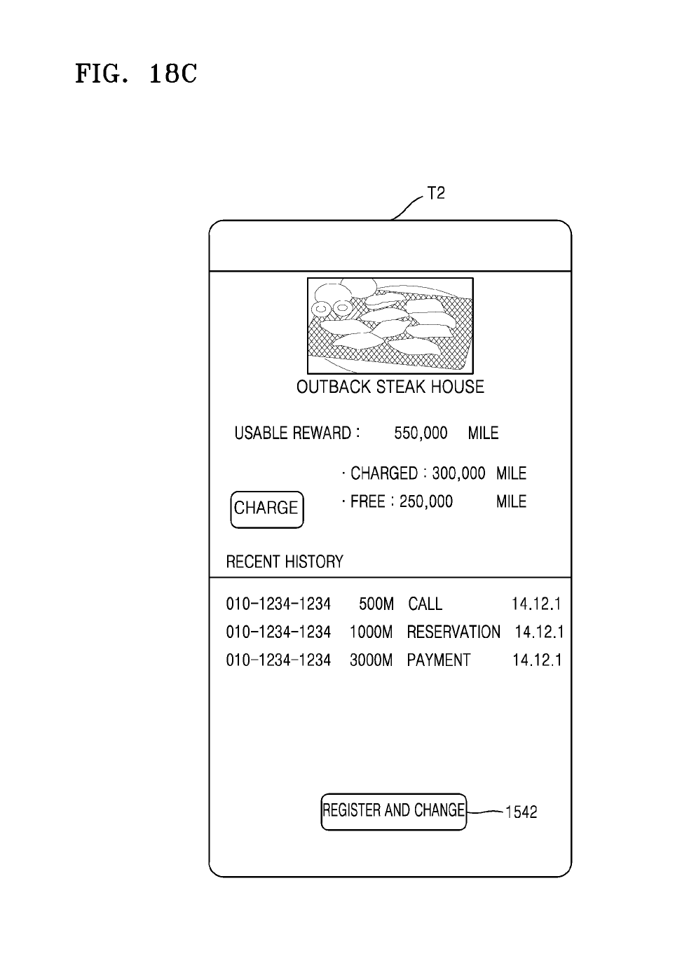

FIG. 18A illustrates a screen in which the fourth additional function 1540 is selected from among the first through fifth additional functions 1510 through 1550 provided to the second user terminal T2 by the system 100. The fourth additional function 1540 may include a function enabling the second user to charge and manage a reward to be provided to the first user terminal T1.

Referring to FIG. 18B, the second user may join a reward affiliate by selecting a reward affiliate join button 1541 displayed on the second user terminal T2. Here, reward affiliates may share rewards to provide service to the first user. For example, the second user who runs a restaurant and the second user who runs a chauffeur service may share rewards. In other words, the first user may receive a reward by visiting the second user who runs a restaurant and use the reward by using the chauffeur service of the second user who runs a chauffeur service.

FIG. 18C illustrates a current reward status and a reward providing history displayed on the second user terminal T2, and a reward may be charged or the reward providing history may be registered or changed by selecting a registering and changing UI 1542.

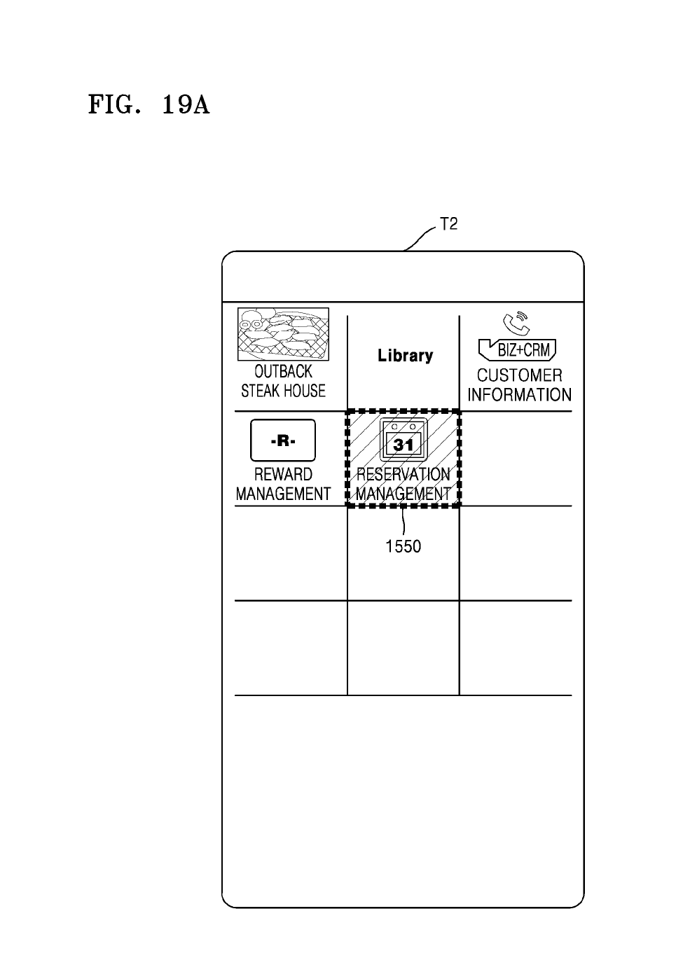

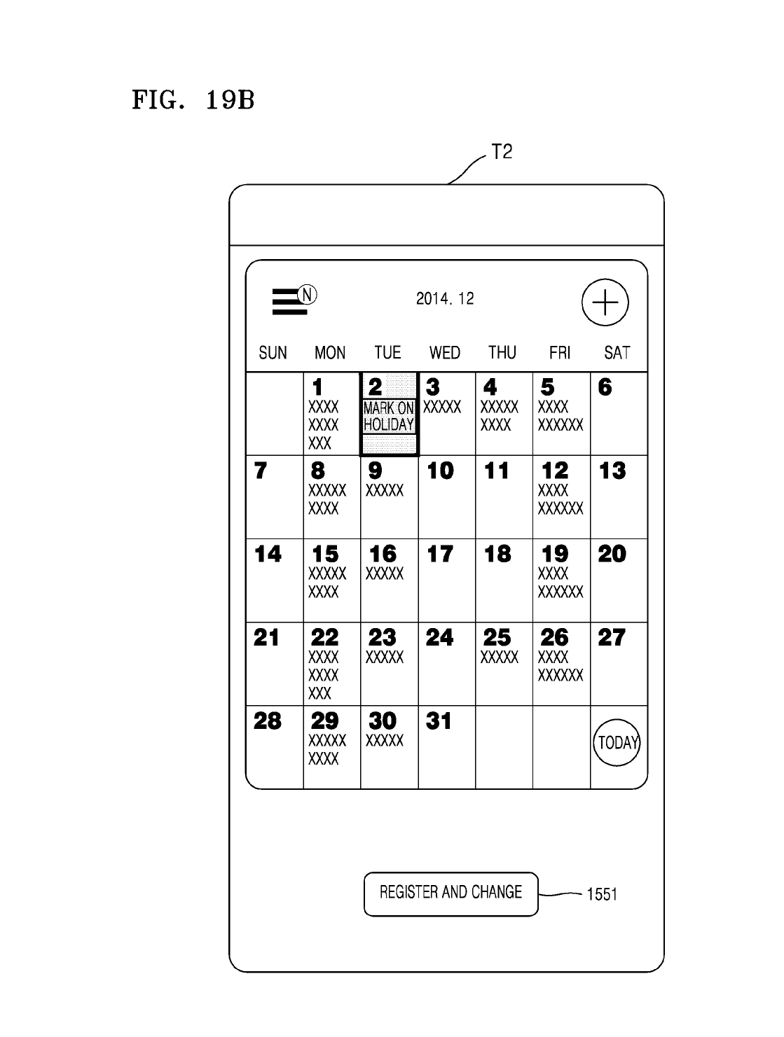

FIG. 19A illustrates a screen in which the fifth additional function 1550 is selected from among the first through fifth additional functions 1510 through 1550 provided to the second user terminal T2 by the system 100. The fifth additional function 1550 may include a function enabling the user to register and change on a calendar the first user who made a reservation.

FIG. 19B illustrates a reservation status of the first user on the calendar displayed on the second user terminal T2, and the reservation status may be registered or changed by selecting a registering and changing UI 1551.

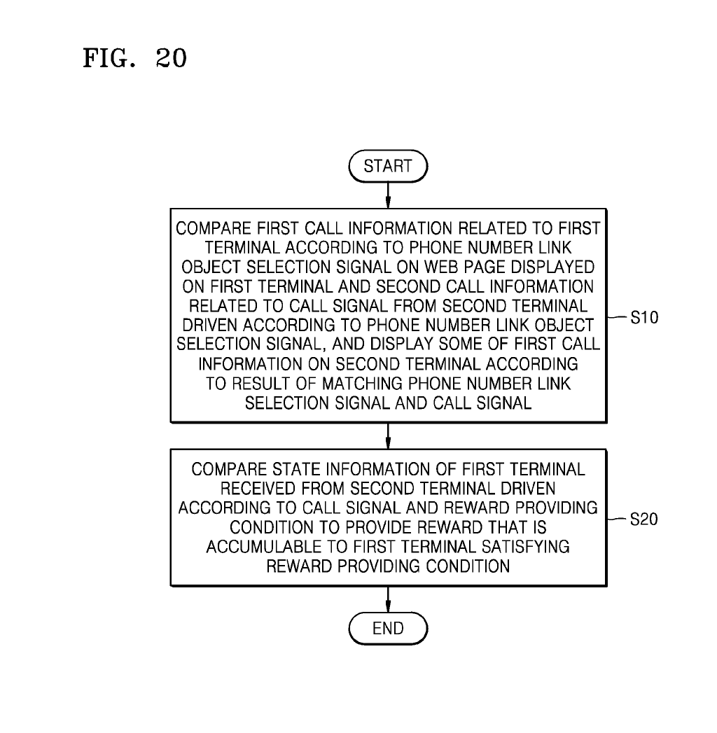

FIG. 20 is a flowchart of a method of providing a reward, according to an embodiment. Details about the method, which overlap those described above with reference to FIGS. 1 through 9, will not be provided again.

Referring to FIG. 20, the system 100 compares the first call information related to the first user terminal T1 according to the phone number link object selection signal on the web page displayed on the first user terminal T1 and the second call information related to the call signal from the second user terminal T2 driven according to the phone number link object selection signal, and displays some (the calling route information) of the first call information on the second user terminal T2 based on a result of matching the phone number link object selection signal and the call signal, in operation S10. Here, the system 100 may provide a call connection between the first and second user terminals T1 and T2 according to the phone number link object selection signal on the web page displayed on the first user terminal T1.

The system 100 compares the state information of the first user terminal T1 received from the second user terminal T2 driven according to the call signal and the reward providing condition to provide the reward that is accumulable to the first user terminal T1 satisfying the reward providing condition, in operation S20.

According to an embodiment, the system 100 may generate the summary information by organizing the call history with the first user terminal T1 in text upon receiving a selection signal of the second user terminal T2 driven according to the call signal, after the phone number link object is selected from the first user terminal T1. The system 100 may provide the reward to the first user terminal T1 according to the generation of the summary information.

According to an embodiment, the system 100 may transmit information requested by the first user terminal T1 to the first user terminal T1 upon receiving a selection signal of the second user terminal T2 driven according to the call signal, after the phone number link object is selected from the first user terminal T1. The system 100 may provide a reward to the first user terminal T1 when the first user terminal T1 requests the second user terminal T2 to transmit a message.

According to an embodiment, the system 100 may set at least one transmission method based on the phone number of the first user terminal T1, the email address of the first user, and the SNS address of the first user, and transmit the reward providing result notification to the first user terminal based on the at least one transmission method.

According to an embodiment, the system 100 may provide first through fifth additional information for the second user terminal T2.

According to an embodiment, useful information about a calling route may be provided to a callee by notifying the callee about how a caller obtained a phone number of the callee.

Also, by providing to business operators information about which advertising medium customers viewed before calling the business operators, the business operators may easily select an advertising medium.

Also, smooth communication may be provided between a customer and a business operator by transmitting various messages related to a business of the business operator to the consumer while the customer and the business operator are talking over the telephone.

Also, a call history may be prepared during or after a telephone conversation between a customer and a business operator and state information (a call, a reservation, a visit, or a payment) of the customer may be stored to efficiently manage the customer.

Also, a business operator may provide, for business promotion, a reward to a customer according to state information of the customer.

Also, a customer who has accumulated rewards may use the rewards to receive various services.

One or more of the above embodiments may be embodied in the form of a computer program that can be run in a computer through various elements. The computer program may be recorded on a non-transitory computer-readable recording medium. Examples of the non-transitory computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Furthermore, the non-transitory computer-readable recording medium may be a formless medium that can be transmitted and distributed in a network, e.g., software or an application.

The computer program may be designed and configured specially for the disclosure by those of ordinary skill in the field of computer software. Examples of the computer program include not only machine language codes prepared by a compiler but also high-level codes executable by a computer by using an interpreter.

The use of the terms “a” and “an” and “the” and similar referents in the context of describing one or more embodiments (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein.

Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the disclosure.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A system in communication with a first terminal and a second terminal for providing a reward to the first terminal based on reward information received from the second terminal, the system comprising:
a calling route information provider configured to compare first call information related to the first terminal according to a phone number link object selection signal on a web page displayed on the first terminal and second call information related to a call signal from the second terminal driven according to the phone number link object selection signal, and display some of the first call information on the second terminal according to a matching determination result of the phone number link object selection signal and the call signal; and
a reward provider configured to compare state information of the first terminal and a reward providing condition received from the second terminal driven by the call signal to provide an accumulable reward to the first terminal satisfying the reward providing condition.

2. The system of claim 1, further comprising a summary information generator configured to generate, upon receiving a selection signal from the second terminal, summary information by summing up a call history with respect to the first terminal.

3. The system of claim 1, further comprising a transmitter configured to transmit information requested by the first terminal to the first terminal upon receiving a selection signal from the second terminal.

4. A method of providing a reward to a first terminal based on reward information from the second terminal, the method comprising:
comparing, by a calling route information provider, first call information related to the first terminal according to a phone number link object selection signal on a web page displayed on the first terminal and second call information related to a call signal from the second terminal driven according to the phone number link object selection signal, and displaying, by a calling route information provider, some of the first call information on the second terminal according to a matching determination result of the phone number link object selection signal and the call signal; and
comparing, by a reward provider, state information of the first terminal and a reward providing condition received from the second terminal driven by the call signal to provide an accumulable reward to the first terminal satisfying the reward providing condition.

5. The method of claim 4, further comprising, generating, by a summary information generator, summary information by summing up a call history with respect to the first terminal upon receiving a selection signal from the second terminal.

6. The method of claim 4, further comprising, transmitting, by a transmitter, information requested by the first terminal to the first terminal upon receiving a selection signal from the second terminal.

7. A computer program stored in a non-transitory computer readable medium for providing a reward to a first terminal based on reward information from the second terminal, the program when executed by a computer causing the computer to perform the step comprising:
comparing, by a calling route information provider, first call information related to the first terminal according to a phone number link object selection signal on a web page displayed on the first terminal and second call information related to a call signal from the second terminal driven according to the phone number link object selection signal, and displaying, by a calling route information provider, some of the first call information on the second terminal according to a matching determination result of the phone number link object selection signal and the call signal; and
comparing, by a reward provider, state information of the first terminal and a reward providing condition received from the second terminal driven by the call signal to provide an accumulable reward to the first terminal satisfying the reward providing condition.
